(19) United States
(12) Patent Application Publication
(10) Pub. No.: US 2026/0030332 A1
(43) Pub. Date: Jan. 29, 2026

(54) ENHANCED SOUND-RELATED AND GESTURE-RELATED AUTHENTICATION

(71) Applicant: TDK USA Corporation, Uniondale, NY (US)

(72) Inventors: Daniela Hall, Eybens (FR); Soufiane Atouani, Grenoble (FR); Remi Poncot, Grenoble (FR); Sina Khanagha, Grenoble (FR)

(21) Appl. No.: 19/253,062

(22) Filed: Jun. 27, 2025

Related U.S. Application Data
(60) Provisional application No. 63/674,763, filed on Jul. 23, 2024.

(51) Int. Cl. G06F 21/32; G06F 3/01

(52) U.S. Cl. CPC G06F 21/32; G06F 3/017

(57) ABSTRACT

Enhanced sound-related and gesture-related authentication can be performed and managed. An authenticator can receive authentication information, comprising audio, bone conduction, and/or body gesture related authentication information, associated with an unauthenticated user from the unauthenticated user or an unauthenticated device associated with the unauthenticated user. Authenticator can determine whether to authenticate unauthenticated user and/or device based on analysis of the authentication information and stored authentication information, comprising stored audio, stored bone conduction, and/or stored body gesture related authentication information, associated with a verified user and/or verified device associated with verified user. If authenticator determines that authentication information satisfies defined match criteria with respect to stored authentication information, authenticator can determine unauthenticated user and/or device can be authenticated as the verified user and/or device. If authenticator determines the defined match criteria is not satisfied, authenticator can determine unauthenticated user and/or device cannot be authenticated.

### CROSS-REFERENCE TO RELATED APPLICATION

This patent application claims priority to U.S. Provisional Patent Application No. 63/674,763, filed Jul. 23, 2024, and entitled, “Voice authentication enhancement using accelerometer for head-worn devices,” the entirety of which application is hereby incorporated by reference herein.

### BACKGROUND

Different types of authentication can be employed to authenticate users and/or associated devices. As some examples, passwords, passcodes, personal identification numbers (PINs), or biometric identification (e.g., face identification, fingerprint identification) can be utilized to authenticate users and/or associated devices.

The above-described description is merely intended to provide a contextual overview relating to authentication of users and/or devices, and is not intended to be exhaustive.

### SUMMARY

The following presents a simplified summary of various aspects of the disclosed subject matter in order to provide a basic understanding of some aspects described herein. This summary is not an extensive overview of the disclosed subject matter. It is intended to neither identify key or critical elements of the disclosed subject matter nor delineate the scope of such aspects. Its sole purpose is to present some concepts of the disclosed subject matter in a simplified form as a prelude to the more detailed description that is presented later.

In some embodiments, the disclosed subject matter can comprise a system that can comprise a receiver component that can receive audio-related authentication information and at least one of bone conductive authentication information or body gesture-related authentication information that can be associated with an unauthenticated user from the unauthenticated user or an unauthenticated device that can be associated with the unauthenticated user. The system also can comprise an authenticator component that can determine whether to authenticate at least one of the unauthenticated user or the unauthenticated device based on a result of an analysis of the audio-related authentication information and the at least one of the bone conductive authentication information or the body gesture-related authentication information, and stored audio-related authentication information and at least one of stored bone conductive authentication information or stored body gesture-related authentication information that can be associated with a user or a device associated with the user.

In certain embodiments, the disclosed subject matter can comprise a device that can comprise a receiver component that can receive at least one of bone conductive authentication information or body gesture-related authentication information associated with an unauthenticated user from the unauthenticated user or an unauthenticated device that can be associated with the unauthenticated user. The device also can comprise an authenticator component that can determine whether to authenticate at least one of the unauthenticated user or the unauthenticated device based on a result of an evaluation of the at least one of the bone conductive authentication information or the body gesture-related authentication information, and at least one of stored bone conductive authentication information or stored body gesture-related authentication information that can be associated with a verified user or a verified device associated with the verified user.

In certain other embodiments, the disclosed subject matter can comprise a method that can comprise analyzing, by a system comprising at least one processor, audio-related authentication information associated with an unauthenticated user or an unauthenticated device, and stored audio-related authentication information associated with a verified user or a verified device associated with the verified user, wherein the audio-related authentication information can be received from the unauthenticated user or the unauthenticated device associated with the unauthenticated user. The method also can comprise determining, by the system, whether to authenticate at least one of the unauthenticated user or the unauthenticated device based on a result of the analyzing of the audio-related authentication information and the stored audio-related authentication information, wherein a first portion of the audio-related authentication information can relate to a first interaction between a first sound signal and a first body part associated with the unauthenticated user, and wherein a second portion of the stored audio-related authentication information can relate to a second interaction between a second sound signal and a second body part associated with the verified user.

The following description and the annexed drawings set forth in detail certain illustrative aspects of the disclosed subject matter. These aspects are indicative, however, of but a few of the various ways in which the principles of the disclosed subject matter may be employed, and the disclosed subject matter is intended to include all such aspects and their equivalents. Other advantages and distinctive features of the disclosed subject matter will become apparent from the following detailed description of the disclosed subject matter when considered in conjunction with the drawings.

### BRIEF DESCRIPTION OF THE DRAWINGS

FIG. 1 illustrates a block diagram of an example system that desirably can perform and manage authentication of users (and/or associated devices) utilizing enhanced sound-related and gesture-related authentication, in accordance with various aspects and embodiments of the disclosed subject matter.

FIG. 2 depicts a block diagram of a non-limiting example sensor component, in accordance with various aspects and embodiments of the disclosed subject matter.

FIG. 3 illustrates a block diagram of an authenticator component, in accordance with various aspects and embodiments of the disclosed subject matter.

FIG. 4 depicts a diagram of a non-limiting example authentication information generation process that can involve generation of authentication information by a user wearing a device, in accordance with various aspects and embodiments of the disclosed subject matter.

FIG. 5 depicts a diagram of a system that can employ ear auditory canal measurements and/or bone conduction signatures associated with cars of users, and/or unicity associated with such auditory canal measurements and/or bone conduction signatures, to facilitate authentication of users, in accordance with various aspects and embodiments of the disclosed subject matter.

FIG. 6 illustrates a flow diagram of an example method that that can desirably perform and manage authentication of users (and/or associated devices) utilizing enhanced sound-related and gesture-related authentication, in accordance with various aspects and embodiments of the disclosed subject matter.

FIG. 7 depicts a flow diagram of another example method that can desirably perform and manage authentication of users (and/or associated devices) utilizing enhanced sound-related and gesture-related authentication, in accordance with various aspects and embodiments of the disclosed subject matter.

FIGS. 8 and 9 illustrate a flow diagram of an example method that that can desirably perform and manage authentication of users (and/or associated devices) utilizing enhanced sound-related authentication relating to ear canal measurement and/or unicity of ear canal measurements, in accordance with various aspects and embodiments of the disclosed subject matter.

FIG. 10 depicts a flow diagram of an example method that that can desirably perform and manage authentication of users (and/or associated devices) utilizing enhanced sound-related authentication relating to bone conduction characteristics associated with an car of an unauthenticated user and/or unicity of bone conduction characteristics associated with the cars of the unauthenticated user, in accordance with various aspects and embodiments of the disclosed subject matter.

FIG. 11 illustrates an example block diagram of an example computing environment in which the various embodiments of the embodiments described herein can be implemented.

### DETAILED DESCRIPTION

The disclosed subject matter is described with reference to the drawings, wherein like reference numerals are used to refer to like elements throughout. In the following description, for purposes of explanation, numerous specific details are set forth in order to provide a thorough understanding of the various embodiments of the subject disclosure. It may be evident, however, that the disclosed subject matter may be practiced without these specific details. In other instances, well-known structures and devices are shown in block diagram form in order to facilitate describing the various embodiments herein.

This disclosure generally relates to authentication of users and devices, for example, to enhanced sound-related and gesture-related authentication of users and devices. Voice authentication is one type of authentication that can be performed to authenticate or verify an unauthenticated user and/or an unauthenticated device associated with the unauthenticated user. Applications for voice authentication can comprise, for example, security measures in smart home systems, smart speakers, virtual assistant devices, and/or Internet of Things (IOT) devices; phone calls by users to banking and financial services (e.g., to secure transactions and reduce fraud), telecommunication services, healthcare services, customer support center services, and/or other types of services; government agencies, public safety, and/or corporate enterprises (e.g., to identify fraud, identify a suspected individual who may be engaging in fraud or other wrongful conduct, and/or authenticate voice recordings submitted as evidence); and/or other desired types of applications (e.g., applications where verification of the voices of users can be desired and/or security of information of users can be desired).

However, existing authentication techniques, including existing voice authentication techniques, can be deficient for a variety of reasons. For instance, with regard to existing voice authentication systems, methods, and techniques, a malicious user (e.g., a malicious attacker or spoofer) can record (e.g., surreptitiously record) the voice of a user, and can use the recorded voice of the user, for example, by playing the recorded voice of the user through a speaker, to falsely represent the malicious user as being the user and authenticate with the system as the user. As another example, a malicious user can create a deep fake of the voice of a user (e.g., can create a synthesized or processed voice that can emulate or otherwise sound a lot like the voice of the user) and can use the deep fake voice purporting to be the user, for example, by playing the deep fake voice purporting to be the user through a speaker, to falsely represent the malicious user as being the user and authenticate with the system as the user. Also, environmental air-conducted noise, in realistic scenarios, can considerably degrade the performance of typical existing artificial intelligence (AI)-based (e.g., deep neural network (DNN)-based) speaker recognition models. As a result, with regard to existing voice authentication systems, methods, and techniques, voice authentication typically is not sufficiently suitable and reliable to use to authenticate users (and associated devices), and multi-factor authentication usually can be employed where voice authentication and another type of authentication technique may be employed to authenticate users (and associated devices).

To overcome the various issues and deficiencies of existing systems, methods, and techniques with regard to authentication, the disclosed subject matter can employ techniques, systems, devices, and methods that can desirably (e.g., suitably, accurately, efficiently, reliably, enhancedly, and/or optimally) perform and manage authentication of users (and/or associated devices) utilizing enhanced sound-related and gesture-related authentication, in accordance with various aspects and embodiments of the disclosed subject matter. A system or device can comprise
Enhanced sound-related and gesture-related authentication can be performed and managed. In accordance with various embodiments, a system can comprise an authenticator component (e.g., enhanced authenticator component) that can perform and manage enhanced sound-related and gesture-related authentication of users and associated devices. In some embodiments, the authenticator component can enroll respective users and/or associated respective devices based at least in part on respective verification information associated with the respective users (e.g., to verify who a user is when enrolling) and respective enrollment authentication information that can be stored, as respective stored authentication information, in a data store of or associated with the authenticator component. The stored authentication information associated with a user can comprise audio-related, bone vibration or conduction-related, and/or body gesture-related authentication information. In some embodiments, the authenticator component, and the enhanced authentication techniques and methods that can be employed by the authenticator component, desirably (e.g., suitably, enhancedly, or optimally) can employ multiple modality fusion (e.g., fusion of audio-related modality, bone vibration or conduction-related modality, body gesture-related modality, and/or another modality) to enhance (e.g., improve, increase, or optimize) performance of authentication of users and/or associated devices (e.g., improve or increase accuracy of authentication determinations), such as described herein. Multiple modality fusion for authentication can provide improved performance for authentication determinations and other advantages as compared to single modality techniques for authentication (e.g., performing voice authentication of a user based on speech of the user).

When an unauthenticated user and/or associated unauthenticated device attempts to authenticate with the authenticator component (and/or an application, service, device, and/or other entity associated therewith), the authenticator component can receive authentication information, comprising audio-related, bone vibration or conduction-related, and/or body gesture-related authentication information, associated with the unauthenticated user from the unauthenticated user or the associated unauthenticated device. The authenticator component (e.g., employing an enhanced trained AI-based model(s)) can determine whether to authenticate the unauthenticated user and/or the associated unauthenticated device based at least in part on the results of an analysis (e.g., AI-based analysis) of the authentication information (e.g., the audio-related, bone vibration or conduction-related, and/or body gesture-related authentication information) associated with the unauthenticated user and/or associated unauthenticated device and the stored authentication information (e.g., stored audio-related, bone vibration or conduction-related, and/or body gesture-related authentication information) associated with a verified (e.g., enrolled and verified) user and/or associated verified device associated with the verified user. If the authenticator component determines that the received authentication information satisfies defined match criteria with respect to the stored authentication information, the authenticator component can determine that the unauthenticated user can be authenticated as the verified user and/or the associated unauthenticated device can be authenticated as the associated verified device, and the authenticator component can authenticate and grant access, or facilitate granting access, to the authenticated user and/or authenticated device (e.g., facilitate granting access to an account, a file, a data store, an application, a service, a platform, or other entity associated with the verified user and/or associated verified device). If, instead, the authenticator component determines that the received authentication information does not satisfy the defined match criteria with respect to the stored authentication information, the authenticator component can determine that the unauthenticated user cannot be authenticated as the verified user and/or the associated unauthenticated device cannot be authenticated as the verified device, and can decline (e.g., refuse) to authenticate and/or grant access to (e.g., can decline, refuse, or prevent access to the account, file, data store, application, service, platform, or other entity to or by) the unauthenticated user and/or the associated unauthenticated device.

The disclosed subject matter, by employing the enhanced authenticator component and the enhanced authentication techniques (e.g., techniques relating to use of bone vibration or conduction-related authentication information, body gesture-related authentication information, ear canal measurement-related authentication information, and/or ear bone conduction signature-related authentication information; techniques relating to fusion of multiple authentication modalities (and multiple types of authentication information); and other enhanced authentication techniques) described herein, can desirably (e.g., suitably, efficiently, reliably, enhancedly, and/or optimally) perform authentication determinations relating to users, with enhanced authentication determination performance and enhanced performance of AI-based models in making authentication determinations and inferences, as compared to existing authentication systems, methods, and techniques. Also, the disclosed subject matter, by employing the enhanced authenticator component and the enhanced authentication techniques described herein, can desirably (e.g., suitably, efficiently, reliably, enhancedly, and/or optimally) provide an additional and/or enhanced layer of security against malicious attacks (e.g., spoofing attacks) to prevent or substantially mitigate malicious attacks (e.g., the enhanced AI-based models disclosed herein can prevent spoofing that uses the air-conducted portion of audio of a person to attempt a spoof attack by recording the voice of the person using a microphone and using that voice recording to attempt the spoof attack), and can enable voice-related biometric authentication to be comparable in performance with face identification and fingerprint identification for authentication. For instance, the enhanced authenticator component and the enhanced authentication techniques can enable the authenticator component to have a desirably high accuracy in detecting malicious attacks (e.g., spoof attacks or other improper attempts at being authenticated), can have a desirably low error rate in improperly authenticating a malicious user (e.g., a malicious attacker or spoofer), and can have a desirably low error rate in improperly declining to authenticate a verified user.

These and other aspects of the disclosed subject matter are described with regard to the figures.

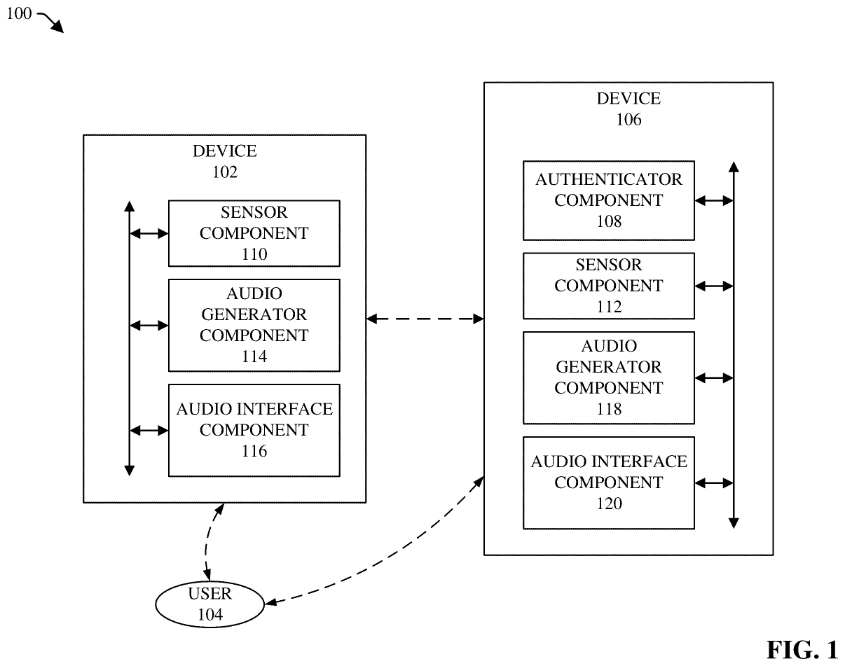

Turning to FIG. 1, illustrated is a block diagram of an example system 100 that desirably (e.g., suitably, accurately, efficiently, reliably, enhancedly, and/or optimally) can perform and manage authentication of users (and/or associated devices) utilizing enhanced sound-related and gesture-related authentication, in accordance with various aspects and embodiments of the disclosed subject matter. The system 100 can comprise a device 102 that can be associated with a user 104, and a device 106 that can comprise an authenticator component 108 (e.g., enhanced authenticator component) that can determine whether to authenticate, and/or authenticate, unauthenticated users (e.g., the user 104, prior to authentication) and/or unauthenticated devices (e.g., the device 102, prior to authentication). In some embodiments, the authenticator component 108 can employ multiple modality fusion and multiple modality AI-based fusion models (e.g., trained AI-based fusion speech recognition, verification, and/or authentication models), wherein the multiple modality fusion can comprise, for example, fusion of audio-related modality, bone vibration or conduction-related modality, body gesture-related modality, and/or another modality, such as described herein. In accordance with various embodiments, the device 106 can be associated with (e.g., directly or indirectly associated with) the user 104.

In accordance with various embodiments, the device 102 and/or the device 106 can be or can comprise at least one of an earbud or earphone device (e.g., true wireless stereo (TWS) earbud of earphone device or other type of earbud or earphone device), an electronic headset device, an electronic eyeglasses device, an augmented reality (AR)-virtual reality (VR) headset device, or other type of communication device (e.g., a computer, a mobile phone or smart phone, an electronic pad or tablet, or other type of communication device). In accordance with various embodiments, the device 102 and/or the device 106 can be a communication device that can comprise an earbud or earphone device, headset device, electronic eyeglasses device, or other device in that the device 102 and/or the device 106 can be associated with (e.g., communicatively connected to via a wired or wireless communication connection) the earbud or earphone device, headset device, electronic eyeglasses device, or other device. In that regard, in certain embodiments, a device (e.g., 102 or 106) can be a wireless, mobile, or smart phone, a computer, a laptop computer, a server, an electronic pad or tablet, a virtual assistant (VA) device, electronic eyewear, an electronic watch, an electronic headset device, or other electronic bodywear, an AR/VR device, an electronic gaming device, an Internet of Things (IOT) device (e.g., a health monitoring device, a toaster, a coffee maker, blinds, a music player, speakers, a telemetry device, a smart meter, a machine-to-machine (M2M) device, or other type of IoT device), a device of a connected vehicle (e.g., car, airplane, train, rocket, and/or other at least partially automated vehicle (e.g., drone)), a personal digital assistant (PDA), a communication device, or other type of device. For example, the device 102 or the device 106 can be a mobile phone or smart phone that can comprise or can be associated with an earbud or earphone device, which can be considered part of the device 102 or the device 106.

In some embodiments, a user (e.g., the user 104 or other user) can be attempting to authenticate with the device 106 indirectly via the device 102 (e.g., the device 102 can be or can comprise the earbud or earphone device, electronic headset device, electronic eyeglasses device, AR-VR headset device, or other type of communication device that the user uses or interacts with directly (e.g., wears or otherwise uses or interacts with directly)) to communicate with the device 106 to authenticate with the device 106 (or an application, service, and/or other entity associated therewith). In certain other embodiments, the user (e.g., the user 104 or other user) can be attempting to authenticate with the device 106 directly (e.g., the device 106 can be or can comprise the earbud or earphone device, electronic headset device, electronic eyeglasses device, AR-VR headset device, or other type of communication device that the user uses or interacts with directly (e.g., wears or otherwise uses or interacts with directly)). For example, the user (e.g., the user 104 or other user) can be directly utilizing (e.g., wearing or otherwise utilizing) the device 106 to attempt to authenticate with the device 106. It is to be appreciated and understood that, while some of the aspects and embodiments of the disclosed subject matter may be described herein with regard to the user utilizing and/or interacting with the device 102 to attempt to authenticate with the device 106 (or the application, service, and/or other entity associated therewith), the enhanced authentication techniques, methods, and algorithms described herein also can be applied or extended to non-limiting example scenarios where the user can be utilizing the device 106 to directly interact with the device 106 to attempt to authenticate with the device 106 (or the application, service, and/or other entity associated therewith).

In accordance with various embodiments, the device 102 can comprise a sensor component 110, and/or the device 106 can comprise a sensor component 112, that can comprise various sensors. In accordance with various embodiments, the sensor component 110 and/or the sensor component 112 can comprise a microphone(s), a sound sensor component(s), a bone vibration or conduction sensor component(s), an accelerometer component(s), a gyroscope component(s), an inertial measurement unit(s) (IMU(s)), a piezo sensor component(s), and/or another type of sensor(s) that can sense (e.g., detect and/or measure, or facilitate measuring) respective types of signals, conditions, characteristics (e.g., attributes, properties, traits, qualities, or features), and/or other information, such as described herein. In some embodiments, the sensor component 110 and/or the sensor component 112 (e.g., one or more of the sensors of the sensor component 110 and/or the sensor component 112) can be or can comprise a microelectromechanical systems (MEMS) or semiconductor sensor component that can comprise a MEMS or semiconductor sensor that can be formed using MEMS technology.

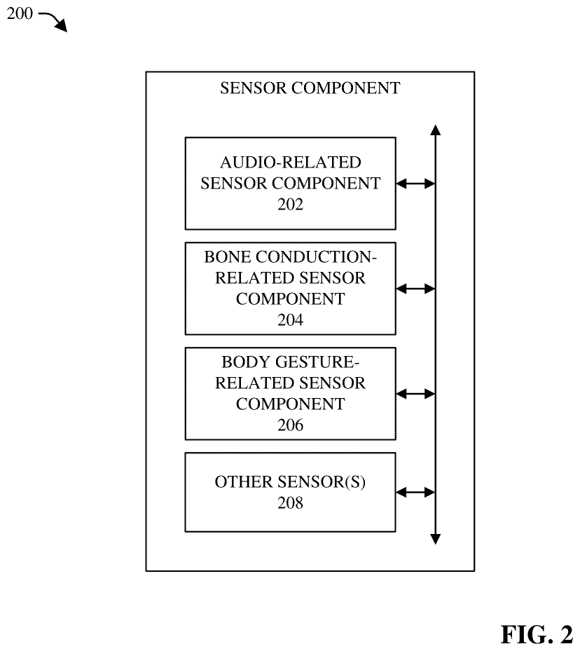

Referring to FIG. 2 (along with FIG. 1), FIG. 2 depicts a block diagram of a non-limiting example sensor component 200, in accordance with various aspects and embodiments of the disclosed subject matter. In accordance with various embodiments, the sensor component 110 and/or the sensor component 112 can be the sensor component 200. In accordance with various embodiments, the sensor component 200 can comprise an audio-related sensor component 202 that can comprise one or more audio-related sensors, a bone conduction-related sensor component 204 that can comprise one or more bone conduction-related sensors, a body gesture-related sensor component 206 that can comprise one or more body gesture-related sensors, and/or one or more other sensors 208.

In some embodiments, the audio-related sensor component 202 can comprise one or more microphones and/or other sound sensors, and/or one or more other audio-related sensors that can sense audio-related signals, conditions, characteristics, and/or other information (e.g., of a user, such as the user 104). In accordance with various embodiments, the audio-related sensor component 202 can sense voice signals, conditions, characteristics, and/or other information of a voice of a user (e.g., the user 104 or other user), and/or audio-related response signals conditions, characteristics, and/or other information sensed or obtained from an ear canal(s) of the user in response to emitting audio signals (e.g., one or more audio pulses) into the ear canal(s) of the user, such as described herein.

In certain embodiments, the bone conduction-related sensor component 204 can be or can comprise an accelerometer component, a gyroscope component, an IMU, a piezo sensor component, and/or other bone vibration or conduction-related sensor that can sense bone vibration or conduction-related signals, conditions, characteristics, and/or other information (e.g., of a user, such as the user 104). In some embodiments, the bone conduction-related sensor component 204 can comprise one or more sensors that can be in relatively close contact to, or in sufficiently close proximity to, the bone (e.g., skull or other desired bone) of a user (e.g., user 104) to be able to capture the bone vibrations or conductions of the bone of the user (e.g., the sensor can be in contact with the head of the user). The sensing of bone vibration or conduction-related signals by the bone conduction-related sensor component 204 typically can have certain advantages, such as, for example, such sensing of bone vibrations or conduction associated with a user typically can have relatively cleaner low frequency content with a desirably higher signal-to-noise ratio (SNR) and can be immune or substantially immune to air-conducted adversities (e.g., reverberation, background noise, or other undesirable air-conducted conditions). It is noted that such sensing of bone vibrations or conduction associated with a user may not capture higher frequency content (e.g., above 2 kilohertz (kHz) or other relatively higher frequency), depending in part on the features of such sensor, and there may be a lower intelligibility of certain sounds (e.g., words spoken by the user), although a microphone can still sense and capture that information.

With further regard to bone vibration or conduction-related signals, the fundamental frequency can be the lowest frequency of a sound wave, and, in the context of speech processing, it can correspond to the rate at which the vocal folds of a user can vibrate during the phonation process. It can be perceived as the pitch of the voice. Further, the integer multiples of the fundamental frequency can be referred to as harmonics relative to the fundamental frequency. While the fundamental frequency can set the pitch of the sound, harmonics can contribute to the timbre of the voice of the user, which can give the voice richness and complexity.

Another significant characteristic of human speech can be the formants. Formants can be the resonant frequencies of the vocal tract. They can be the peaks in the frequency spectrum of the sound wave that can correspond to the specific frequencies where the vocal tract amplifies certain harmonics. Formants can be significant in determining the vowel sounds in speech. The first format (F1) and the second formant (F2) can be particularly significant for distinguishing between different vowels.

Vowel production can start by the vibrations of the vocal cords of the user at a fundamental frequency that typically can range between 80 to 250 hertz (Hz) for adults. These vibrations can be acoustically coupled to the vocal tract, which can radiate an acoustic pressure wave filtered out by various cross sections of this air guide, modulating the wave in multiple formants up to approximately 8 kHz, depending primarily on the tongue and lips positions of the user and shape to create different vowels. In parallel, vocal cord vibrations also can induce a harmonic force on its extremities that can propagate through the head of the user as solid waves, which can be filtered out by the different human tissues, such as bones, flesh, and blood vessels and physiological characteristics, such as head form, size, and tongue placement of the user, which can lead to a different modulation than the formants of the vocal tract path. This modulation can vary between individuals and vowels, which can bring a set of biometrics variables (in addition to other biometrics variables). These variables can be measured (e.g., by the sensor component 200 and/or the authenticator component 108), where, for example, bone-conducted speech can be sensed and recorded by the bone conduction-related sensor component 204 (e.g., accelerometer) along with the audio-related sensor component 202 (e.g., microphone) where users can be holding different vowels for a certain amount of time (e.g., a few seconds, or other desired shorter or longer amount of time). An envelope that can characterize each wave propagation path can be extracted (e.g., by the authenticator component 108 or other component) using cepstrum on normalized acceleration and pressure signal. Observed differences in these curves can confirm the uniqueness of the bone-conduction path for each individual.

Bone-conducted speech can be recorded (e.g., by the authenticator component 108 and/or the bone conduction-related sensor component 204 (e.g., accelerometer implemented inside an earbud device, headset device, or other device)) by tracking the vibrations of the human skull. Although the bone-conduction modality of speech can have a relatively limited bandwidth (e.g., as compared to air-conducted speech), which, in turn, can result in a relatively lower intelligibility, the bone-conduction modality can be inherently immune to air-conducted adversities. Consequently, the bone-conduction modality can be of relatively high value for speech enhancement and improving the robustness of speech processing models, and can be desirable to enhance speech verification and authentication of users. It is noted that, in addition to the bone vibrations and/or conductions of a user being unique to that user (e.g., different users can have different bone vibration and/or conduction characteristics), the respective bone vibrations and/or conductions of respective ears (e.g., left ear and right car) of a user can be unique (e.g., the left ear of the user can have first bone vibration and/or conduction characteristics and the right ear of the user can have second bone vibration and/or conduction characteristics). The authenticator component 108 can take into account the uniqueness of the respective bone vibration and/or conduction characteristics of the respective users, and the uniqueness of the respective bone vibration and/or conduction characteristics of the respective ears of each user when training AI-based models to recognize, verify, and/or authenticate respective users, and when AI-based models (of or associated with the authenticator component 108) are utilized to perform AI-based analysis on respective bone vibration or conduction-related information associated with respective users to recognize, verify, and/or authenticate the respective users and/or make other determinations or inferences.

In some embodiments, the body gesture-related sensor component 206 can be or can comprise the accelerometer component, gyroscope component, IMU, piezo sensor component, and/or other body gesture-related sensor that can sense body gesture-related signals, conditions, characteristics, and/or other information (e.g., of a user, such as the user 104). In certain embodiments, the one or more other sensors 208 can comprise one or more other biometric sensors (e.g., biometric sensors that can sense face characteristics, fingerprint characteristics, eye characteristics, and/or other biometric characteristics of a user, such as the user 104), one or more environmental sensors (e.g., temperature sensor, humidity sensor, pressure sensor, particulate sensor, or other environmental sensor), one or more health-related sensors (e.g., temperature, heart, pulse, blood sugar, blood oxygen, respiration, biophysical sensor, biochemical sensor, and/or other health-related sensor), one or more location sensors (e.g., device or user location sensor), and/or one or more other types of sensors. In some embodiments, the one or more other sensors 208 can be, can comprise, or can be part of the accelerometer component, gyroscope component, IMU, piezo sensor component, or other type of sensor.

With further regard to the system 100 of FIG. 1, in accordance with various embodiments, the device 102 can comprise an audio generator component 114 and an audio interface component 116, and/or the device 106 can comprise an audio generator component 118 and an audio interface component 120. The audio generator component(s) (e.g., 114 and/or 118) can generate one or more audio pulses (e.g., a pattern of audio pulses) that can be emitted (e.g., via one or more sound speakers of the audio interface component(s) (e.g., 116 and/or 120)) into the ear canal(s) of a user (e.g., the user 104 or other user) and utilized to facilitate measuring an ear canal(s) of the user, determining characteristics of the ear canal(s) of the user, and/or determining a bone conduction signature(s) associated with the car(s) of the user based at least in part on the results of one or more responses to the one or more audio pulses emitted into the car(s) of the user(s), such as described herein.

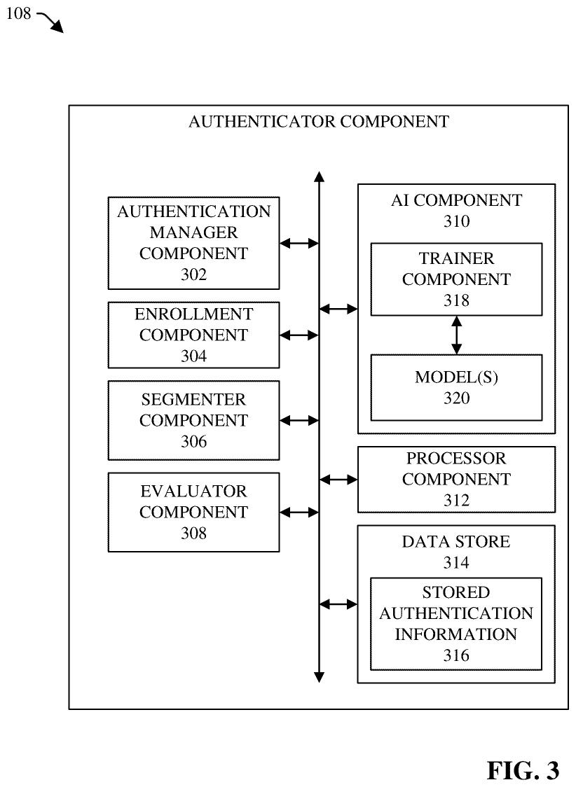

Referring to FIG. 3 (along with FIGS. 1 and 2), FIG. 3 illustrates a block diagram of the authenticator component 108 (e.g., enhanced authenticator component), in accordance with various aspects and embodiments of the disclosed subject matter. In accordance with various embodiments, the authenticator component 108 can comprise an authentication manager component 302, an enrollment component 304, a segmenter component 306, an evaluator component 308, and/or an artificial intelligence (AI) component 310. In certain embodiments, the authenticator component 108 can comprise or can be associated with a processor component 312 and a data store 314, wherein the data store 314 can store authentication information 316 (e.g., respective stored authentication information associated with respective users, including the user 104) and/or other desired data, such as described herein). In some embodiments, the AI component 310 can comprise a trainer component 318 and one or more models 320 (e.g., one or more AI-based models), such as described herein. In accordance with various embodiments, the authentication manager component 302, enrollment component 304, and/or evaluator component 308 can utilizes the AI component 310 to perform various AI-based operations (e.g., determine probabilities, render inferences, make classifications, and/or perform other operations) relating to authentication of users and/or devices, such as described herein.

In some embodiments, the authenticator component 108, employing the enrollment component 304 (e.g., as managed by the authentication manager component 302), can verify and/or enroll into the authentication system one or more respective users, such as the user 104, and/or one or more respective devices (e.g., device 102) associated with the one or more respective users based at least in part on respective enrollment information, which can comprise respective enrollment authentication information and/or respective verification information, associated with the respective users and/or the respective devices, in accordance with the defined authentication management criteria. In certain embodiments, the respective verification information can verify who the one or more respective users are and/or can verify their one of more respective devices in connection with enrolling and registering the one or more respective users and the one or more respective devices with the authenticator component 108 and/or an associated application, service, device (e.g., device 106 or other device), or other entity. For example, the enrollment component 304 can receive first enrollment information, comprising first verification information, first enrollment authentication information, and/or other first enrollment information, from a first user (e.g., the user 104) and/or a first device (e.g., the device 102) associated with the first user, second enrollment information, comprising second verification information, second enrollment authentication information, and/or other second enrollment information, from a second user and/or a second device associated with the second user, and/or other enrollment information, comprising other verification information, other enrollment authentication information, and/or other type of enrollment information, from another user(s) and/or another device(s) associated with the other user(s).

The first verification information associated with the first user can comprise, for example, name, address (e.g., residential address or work address), phone number (e.g., home, cell, and/or work phone number), first device information (e.g., device identifier associated with the first device, device type, device manufacturer, or other information associated with the first device), a first enrollment or registration code value (e.g., a unique enrollment or registration code number or other value), employer, account information (e.g., account number or other account information relating to an account of the first user), and/or other type of verification information of or associated with the first user that can verify who the first user is and/or verify the first device of the first user. The device identifier information can comprise, for example international mobile equipment identity (IMEI), international mobile subscriber identity (IMSI), media access control (MAC) address, embedded identity document (eID), integrated circuit card identifier (ICCID), network address (e.g., Internet protocol (IP) address), serial number, universally unique identifier (UUID), or other type of device identifier. The second verification information associated with the second user and/or the other verification information associated with the other user can comprise similar respective items of verification information (e.g., respective names, respective addresses, respective phone numbers, respective items of device information, respective enrollment or registration code values, and/or other respective items of verification information) associated with the second user and/or the other user.

The first enrollment authentication information associated with the first user can comprise, for example, first enrollment audio-related authentication information (e.g., first voice information, such as words and/or phonemes, spoken by the first user; and/or first audio response signals sensed from the interaction of first audio signals with one or both cars of the first user), first enrollment bone vibration or conduction-related authentication information associated with the first user (e.g., bone vibrations or conductions sensed from the first user speaking words and/or phonemes; bone vibrations or conductions sensed from first interactions (e.g., taps, audio signal interactions, or other interactions) with the head, or one or more cars, of the first user; and/or other bone vibrations or conductions sensed from the first user), first enrollment body gesture-related authentication information (e.g., movement(s) or position(s) of a body part, such as the head, of the first user), and/or other first enrollment authentication information associated with the first user, such as described herein. For instance, the audio-related sensor component 202 can sense, detect, or capture the first enrollment audio-related authentication information, the bone conduction-related sensor component 204 can sense, detect, or capture the first enrollment bone vibration or conduction-related authentication information, the body gesture-related sensor component 206 can sense, detect, or capture the first enrollment body gesture-related authentication information, and/or the one or more other sensors 208 can sense, detect, or capture the other first authentication information associated with the first user.

Similarly, the second authentication information associated with the second user can comprise, for example, second enrollment audio-related authentication information (e.g., second voice information, such as words and/or phonemes, spoken by the second user; and/or second audio response signals sensed from the interaction of second audio signals with one or both cars of the second user), second enrollment bone vibration or conduction-related authentication information associated with the second user (e.g., bone vibrations or conductions sensed from the second user speaking words and/or phonemes; bone vibrations or conductions sensed from second interactions (e.g., taps, audio signal interactions, or other interactions) with the head, or one or more cars, of the second user; and/or other bone vibrations or conductions sensed from the second user), second enrollment body gesture-related authentication information (e.g., movement(s) or position(s) of a body part, such as the head, of the second user), and/or other second enrollment authentication information associated with the second user; and/or the other enrollment authentication information associated with the other user can comprise, for example, other enrollment audio-related authentication information, other enrollment bone vibration or conduction-related authentication information, other enrollment body gesture-related authentication information, and/or other type of enrollment authentication information associated with the other user. For instance, the respective sensors (e.g., respective sensors of the audio-related sensor component, bone conduction-related sensor component, and/or body gesture-related sensor component, and/or one or more other sensors) of the device 106, and/or the second device and/or the other device, can sense, detect, or capture the respective items of the second enrollment authentication information associated with the second user and/or the respective items of the other enrollment authentication information associated with the other user.

The enrollment component 304 (e.g., in conjunction with the evaluator component 308) can determine whether a user (e.g., first user, second user, or other user) is verified as being that user and/or the associated device (e.g., first device, second device, or other device) is verified as being the device of the user, and whether to enroll and/or register the user and/or associated device, based at least in part on the results of analyzing (e.g., evaluating) the verification information provided by the user and/or associated device, in accordance with the defined authentication management criteria, which can comprise criteria relating to verification of users and/or devices, and enrollment and/or registration of users and/or devices. In some embodiments, if the enrollment component 304 (and/or the evaluator component 308) determines that the user is verified as being that user and/or the associated device is verified as being the device of the user, the enrollment component 304 can determine that the user can be verified as being who the user claims to be and/or the associated device can be verified as being the device of such verified user, and the enrollment component 304 can enroll and/or register the verified user (e.g., as an enrolled and/or registered user) and/or verified device (e.g., as an enrolled and/or registered device) with the authenticator component 108 and/or the associated application, service, device (e.g., device 106 or other device), or other entity. The enrollment component 304 also can store the verification information and the enrollment authentication information (e.g., as stored authentication information) associated with the user (e.g., first user, second user, or other user) and/or associated device (e.g., first device, second device, or other device) in the data store 314. In certain embodiments, the authenticator component 108 can utilize the respective stored authentication information associated with the respective users and/or associated respective devices to facilitate determining whether to authenticate an unauthenticated user and/or associated unauthenticated device as being one of the enrolled users and/or associated enrolled devices, such as described herein. In accordance with various embodiments, the authenticator component 108, and the enhanced authentication techniques and methods that can be employed by the authenticator component 108, desirably (e.g., suitably, enhancedly, or optimally) can employ multiple modality fusion (e.g., fusion of audio-related modality, bone vibration or conduction-related modality, body gesture-related modality, and/or another modality) to enhance performance of authentication of users and/or associated devices, such as described herein.

If, instead, the enrollment component 304 determines that the user is not able to be verified and/or the associated device is not able to be verified, the enrollment component 304 can decline to verify and enroll the user and/or the associated device. In certain embodiments, the enrollment component 304 may provide the user and/or device one or more additional opportunities to attempt to enroll with the authenticator component 108 up to a defined threshold maximum number of enrollment attempts, in accordance with the defined authentication management criteria.

With further regard to the enhanced enrollment and authentication techniques, and the enhanced authentication information, in some embodiments, the authentication information associated with a user (e.g., obtained during enrollment or obtained in connection with an authentication attempt) can comprise respective items of authentication information, comprising respective items of audio-related authentication information, bone vibration or conduction-related authentication information, body gesture-related authentication information, and/or other type of authentication information associated with the user in a form of a pattern (e.g., a unique pattern) and/or in a particular order that can be known to the user and the authenticator component 108, but not other users or entities, in accordance with the defined authentication management criteria. For instance, first authentication information associated with a first user (e.g., user 104) can comprise a first group of items of authentication information comprising respective items of information in a first pattern and/or a first order, second authentication information associated with a second user can comprise a second group of items of authentication information comprising respective items of information in a second pattern and/or a second order, and/or other authentication information associated with another user can comprise another group of items of authentication information comprising respective items of information in another pattern and/or another order.

In certain embodiments, with regard bone vibration or conduction-related authentication information and body gesture-related authentication information, the authentication information associated with the user (e.g., user 104) can comprise respective taps or interactions (e.g., by a finger or other object of or associated with the user) at respective locations on the head (e.g., skull) of the user, wherein such respective taps or interactions with the head can create respective bone vibrations that can be detected by the bone conduction-related sensor component 204 of the device (e.g., device 102, such as a headset device or earbud device), and/or the authentication information can comprise respective movements and/or positions of the head (or other body part) of the user and/or the associated device worn by the user, wherein the body gesture-related sensor component 206 of the device can detect the respective movements and/or positions of the head and/or associated device. Since bone-conducted sound transmission can be significantly (e.g., highly or uniquely) individualized and resonance-dominated, a tap or interaction on the head of the user itself can be significantly individualized to the user, and a pattern of respective taps or interactions at respective locations on the head of the user and/or respective movements and/or positions of the head and/or associated device of the user can further individualize such authentication information of the user.

As a non-limiting example, the user (e.g., user 104), using the associated device (e.g., device 102 on the head of the user), can tap the finger at a first location on the head, tap the finger at a second location on the head, and/or can tap the finger at one or more other locations on the head. Before, during, or after the tapping of the finger on the head at the various locations, the user can have the user's head and associated device in a first position (e.g., straight up or substantially straight up), can move (e.g., tilt) the user's head and associated device from the first position to a second position (e.g., 30°, or other desired angle, away from the straight up position), and/or can move the user's head and associated device from the second position to another position (e.g., 60°, or other desired angle, away from the straight up position). In some embodiments, the respective tappings or other interactions with the head can be performed while the user's head and associated device are being moved between respective positions (e.g., first tap at first location on head while head is at first position, second tap at second location on head while head is at second position, and so on).

In some embodiments, the authenticator component 108 (e.g., the evaluator component 308, the AI component 310, the trained model 320, or other component of the authenticator component 108) can use a desired decoding algorithm, such as a dynamic time warping (DTW) algorithm or other desired decoding algorithm, and/or a classifier (e.g., tap and/or movement classifier, and/or a neural network classifier) combined with a state machine (e.g., of the model 320) to decode and/or determine a pattern of respective taps or interactions at respective locations on the head of a user and/or respective movements and/or positions of the head and/or associated device of the user. The desired decoding algorithm can tolerate variations in timing between taps, interactions, and/or body gestures of the user, and thus, can desirably (e.g., suitably, accurately, reliably, efficiently, enhancedly, or optimally) decode the pattern, comprising taps, interactions, and/or body gestures of the user, even if the user has varied the amount of time between respective taps, interactions, and/or body gestures in a particular authentication attempt, as compared to the pattern (e.g., stored authentication information, comprising the stored pattern, of the user), which the user created when the user enrolled with the authenticator component 108, and which is being used to compare against the pattern of the particular authentication attempt as part of the evaluation and authentication determination by the authenticator component 108.

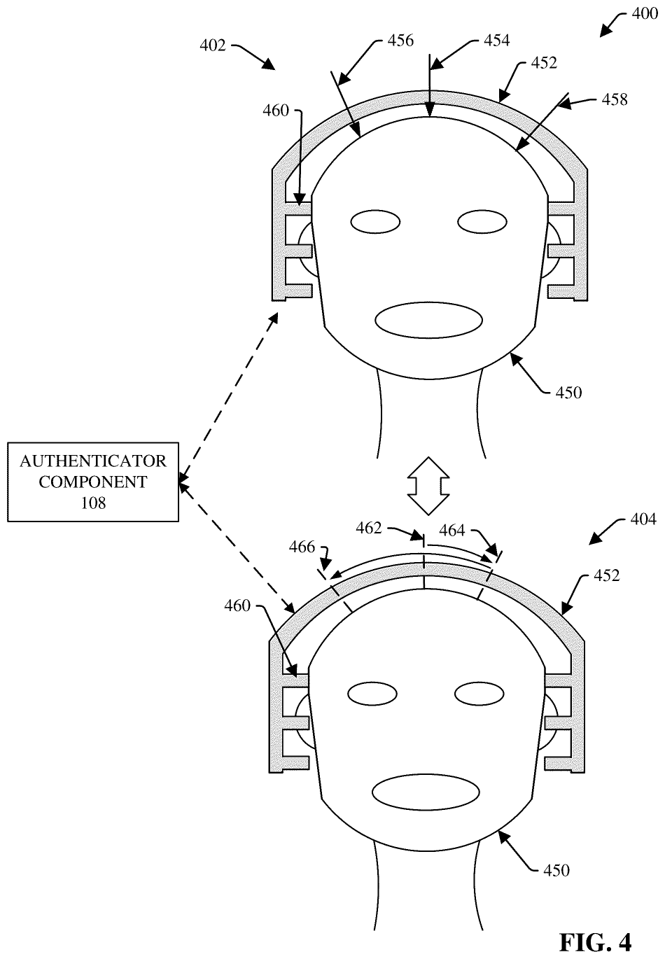

Referring to FIG. 4 (along with FIGS. 1-3), FIG. 4 depicts a diagram of a non-limiting example authentication information generation process 400 that can involve generation of authentication information by a user wearing a device (e.g., headset device, earbud device, or other device), in accordance with various aspects and embodiments of the disclosed subject matter. As indicated at reference number 402 of the example authentication information generation process 400, the user 450, wearing the device 452, can tap a finger or other object of or associated with the user 450 at a first location 454 on the head of the user 450, can tap the finger or other object at a second location 456 on the head of the user 450, and/or can tap the finger or other object at another location 458 on the head of the user 450. The sensor component 460, which can comprise respective sensors (e.g., bone conduction-related sensor component, body gesture-related sensor component, and/or another sensor), can sense the respective taps at the respective locations (e.g., 454, 456, and/or 458) on the head of the user 450, wherein such sensor information relating to the respective taps can be part of the authentication information of the user 450. In certain embodiments, in addition to, or as an alternative to, the user tapping a finger or object on the head of the user 450, the user 450 can tap a finger or object on an earbud(s) of the device 452, which also can result in bone vibration of the head of the user, since the earbud(s) can be in contact with the head of the user 450.

As indicated at reference number 404 of the example authentication information generation process 400, the user 450, wearing the device 452, can move (e.g., tilt or turn) the user's head from a first position 462 to a second position 464 (e.g., at a desired angle relative to the first position 462, wherein the desired angle can be, for example, 30° (or at least approximately 30°) or another desired angle), and/or from the second position 464 to another position 466 (e.g., at another desired angle relative to the first position 462 and/or second position 464). The sensor component 460 can sense the respective movements and positions (e.g., 462, 464, and/or 466) of the head of the user 450, wherein such sensor information relating to the respective movements and/or positions of the user's head can be part of the authentication information of the user 450. In some embodiments, the respective tappings on the head of the user 450, the respective movements and/or positions of the head of the user 450, and/or other authentication information generating actions can be performed in parallel (e.g., concurrently). The combination of sensor information relating to the respective taps, the sensor information relating to the respective movements and/or positions of the user's head, and/or other sensor information (e.g., in a particular pattern or order) can form the authentication information of the user 450.

In certain embodiments, the authenticator component 108 can generate or facilitate generation of respective authentication (e.g., password) mappings associated with respective users. For instance, the authenticator component 108 (e.g., employing the authentication manager component 302, enrollment component 304, and/or another component) generate or facilitate generation of a mapping of respective code words, phrases, or other prompts to respective taps or interactions with the head (or other body part) of the user (e.g., user 104) and/or respective body gestures (e.g., respective positions and/or movements) of the user. As a non-limiting example, the authenticator component 108 can generate an authentication mapping that can comprise a first code word (e.g., Paris) that can be associated with (e.g., mapped or linked to) a first user authentication action (e.g., speaking the word “Yes” two times), a second code word (e.g., Moscow) can be associated with a second user authentication action (e.g., two taps on the right earbud of the device (e.g., device 102)), and a third code word (e.g., Bern) can be associated with a third user authentication action (e.g., two taps on the left earbud of the device). The authenticator component 108 can store this authentication mapping and associated authentication information in the data store 314 as stored authentication information associated with the user and/or the device. It is to be appreciated and understood that other types of prompts and other types of user authentication actions can be utilized to generate an authentication mapping for a user, in addition to or as an alternative to the example prompts and example user authentication actions described herein.

In some embodiments, when the user (e.g., user 104) attempts to authenticate with the authenticator component 108, the authenticator component 108 can generate a password that can comprise the code words associated with the authentication mapping associated with the user, and can have the code words presented to the user via the audio interface (e.g., audio interface component 116, such as a speaker(s)) of the device (e.g., device 102), wherein, in response to the respective code words, the user can perform the respective user authentication actions associated with the respective code words, in accordance with the authentication mapping, to facilitate authenticating the user and/or the associated device with the authenticator component 108. In certain embodiments, the authenticator component 108 can generate the password as a random or pseudorandom password composed of the respective code words (or phrases or prompts) in a randomized order, wherein the user can perform the respective user authentication actions associated with the respective code words in accordance with the randomized order of the presentation (e.g., via the device speaker(s)) of the respective code words (or phrases or prompts) to the user.

In accordance with various embodiments, with regard to bone vibration or conduction-related authentication information associated with the user (e.g., the user 104), the authenticator component 108 can evaluate a bone vibration signature associated with the user that can be a defined length (e.g., approximately 4 seconds or other length of time) or can evaluate a bone vibration signature associated with the user that can be based at least in part on phonemes of words that can be spoken by the user, detected or captured by the bone conduction-related sensor component 204 of the device (e.g., device 102, such as a headset device or earbud device), and analyzed by the authenticator component 108 (e.g., the authentication manager component 302, enrollment component 304, evaluator component 308, AI component 310, or other component), such as described herein. In some embodiments, during the enrollment process to enroll a user (e.g., the user 104) and/or associated device (e.g., the device 102) into the authentication system (e.g., with the authenticator component 108), the enrollment component 304 can prompt the user to say a particular phrase that can comprise all or a desired portion of phonemes to enable the enrollment component 304 to desirably (e.g., accurately, efficiently, enhancedly, or optimally) enroll all or the desired portion of phonemes with respect to that user. The enrollment component 304 can store the speaking of the particular phrase, comprising the phonemes, by the user as part of the stored authentication information for the user.

When an unauthenticated user, such as the user (e.g., the user 104), attempts to authenticate as being the user, the authenticator component 108 can desirably perform authentication, for example, on a phoneme basis, to authenticate (e.g., initially, periodically, continuously, or substantially continuously authenticate) the user as the user speaks words during the interaction with the authenticator component 108 and/or the associated application, service, device (e.g., device 106 or other device), or other entity (e.g., a representative associated with the application or service). In some embodiments, to facilitate performing authentication on a phoneme basis, with regard to an audio signal of the user speaking where the audio signal can comprise, the authenticator component 108, employing the segmenter component 306, can segment the spoken words of the user (e.g., unauthenticated or recently authenticated user) contained in the audio signal to generate phonemes (e.g., distinct speech sounds) contained in the words spoken by the user. The authenticator component 108 also can receive the bone vibration or conduction information that can be detected by the bone conduction-related sensor component 204, wherein respective portions of the bone vibration or conduction information can correspond to the respective words and/or phonemes of the speech of the user during the current interaction with the authenticator component 108. The evaluator component 308 can employ a trained AI-based model of the AI component 310 that can analyze (e.g., perform an AI-based analysis on) the respective phonemes, the respective portions of the bone vibration or conduction information, and the stored authentication information, comprising the stored phoneme information, associated with the enrolled and/or verified user. Based at least in part on the results of the analysis, the trained AI-based model (and/or the evaluator component 308) can determine whether the user (e.g., user 104) and/or associated device (e.g., device 102) can be authenticated, or can continue to be authenticated, as being the verified user and/or verified device. By performing authentication on a phoneme basis, the authenticator component 108 can desirably (e.g., suitably, enhancedly, or optimally) reduce response latency (e.g., authentication response latency) to zero or at least near zero when, for example, the authentication is performed on a continuous or substantially continuous basis, or after the user has spoken a relatively small number of phonemes (e.g., 6 phonemes or less, or other desired smaller number of phonemes). For instance, when the authentication is performed on a continuous or substantially continuous basis, or after the user has spoken a relatively small number of phonemes, the authenticator component 108 typically can authenticate the user in significantly less than 4 seconds (e.g., less than the approximately 4 seconds that it can take to authenticate the user using a non-phoneme AI-based model analysis of a bone conduction signature relating to spoken words of the user).

In accordance with various embodiments, the authenticator component 108 can perform the phoneme-based bone conduction authentication techniques for authentication of users in conjunction with the (e.g., in combination with) body gesture-based (e.g., user body motion or position based) authentication techniques and/or other authentication techniques described herein. This can enable further enhanced (e.g., even more accurate and/or confident) authentication of users and/or associated devices, as there can be enhanced or increased accuracy and/or confidence in an authentication result for an unauthenticated user if multiple authentication techniques are utilized (e.g., where the each of the multiple authentication techniques reach the same authentication result with respect to the unauthenticated user). In some embodiments, using multiple authentication techniques can allow the authenticator component 108 to employ (e.g., apply) more desirable (e.g., lower or less stringent) respective threshold values for the respective authentication techniques, in accordance with the defined authentication management criteria, since the authenticator component 108 is not relying on only one authentication technique to try to authenticate the unauthenticated user. For example, when using first and second authentication techniques, the authenticator component 108 can utilize a relatively lower (e.g., relatively less stringent) first threshold authentication value (e.g., 0.8 probability, instead of 0.9 probability, or other desirably lower threshold authentication value) with regard to the first authentication technique than would otherwise have been employed had the first authentication technique been the only authentication technique used for authentication, and/or the authenticator component 108 can utilize a relatively lower second threshold authentication value with regard to the second authentication technique than would otherwise have been employed had the second authentication technique been the only authentication technique used for authentication.

In accordance with still other embodiments, the authenticator component 108 can perform authentication on an unauthenticated user and/or associated unauthenticated device based at least in part on measurement of an ear auditory canal(s) of the unauthenticated user and/or a bone conduction signature(s) associated with the car(s) of the unauthenticated user, in accordance with the defined authentication management criteria. The form of the car auditory canal can be unique for each user and for each ear of a user. Also, a bone conduction signature can be unique for each user and for each ear of the user. For instance, the asymmetry between the bone conduction signatures of the left and right ears of a user can be different than the respective asymmetries between the respective bone conduction signatures of the respective left and right ears of other respective users.

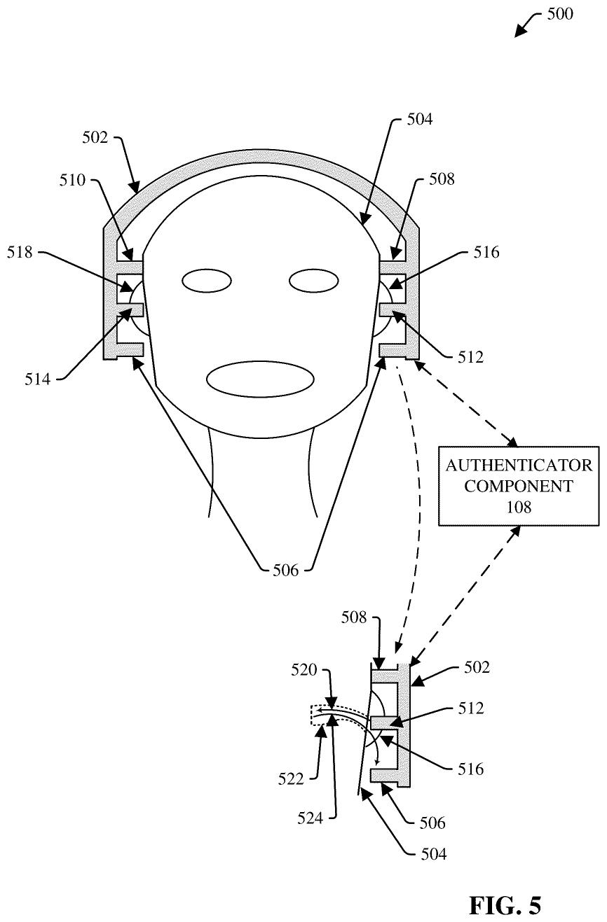

Referring to FIG. 5 (along with FIGS. 1-3), FIG. 5 depicts a diagram of a system 500 that can employ ear auditory canal measurements and/or bone conduction signatures associated with cars of users, and/or unicity associated with such auditory canal measurements and/or bone conduction signatures, to facilitate authentication of users, in accordance with various aspects and embodiments of the disclosed subject matter. In some embodiments, the system 500 can comprise the authenticator component 108 associated with (e.g., communicatively connected to or otherwise associated with) a device 502 (e.g., headset device, earbud device, electronic eyeglasses device, or other type of wearable or partially wearable communication device) that can be worn on a head of a user 504. In accordance with various embodiments, the device 502 can comprise a sensor component that can comprise various sensors, including a microphone(s) 506 that can sense voice or other sound activity of the user 504 (and/or other sounds), one or more sensors (e.g., 508 and/or 510) that can sense bone vibration or conduction activity and/or body gesture activity associated with the user 504, and/or one or more other sensors. The device 502 also can comprise audio speakers 512 and 514 that can be inserted into, against, or otherwise associated with the left car 516 and right ear 518 of the user 504.

In certain embodiments, during enrollment of the user 504, the authenticator component 108 can emit, and/or can initiate or facilitate the emission of (e.g., can request that the device 502 (e.g., using the audio generator component) generate and/or have the audio speaker(s) emit), a group(s) of sound pulses (e.g., group of sound pulses 520), comprising one or more sound pulses, by the audio speaker 512 and/or the audio speaker 514 into the left car 516 and/or the right ear 518 of the user 504. In some embodiments, the group of sound pulses can comprise ultrasound pulses, which can have an audio frequency that can be outside of the human audible hearing range of users, such as the user 504, such that the authentication process utilizing the sound pulses can be transparent to the user (e.g., such authentication process can be performed without explicit interaction or involvement of the user, and the user typically may not be able to perceive that such authentication process is being performed or distracted by such authentication process). This typically can result in a desirably good experience for users, since such authentication process typically can be transparent to the users. The enhanced authentication techniques to measure ear auditory canals of users and use such measurements to facilitate authentication of users and/or associated devices also can be desirably fast (e.g., less than 500 milliseconds), which also can facilitate providing a desirable user experience to users.

The group(s) of sound pulses (e.g., 520) can interact with (e.g., can bounce or reflect off of, can be partially absorbed by, and/or can otherwise interact with) the ear canal 522 (e.g., ear auditory canal) of the left ear 516 and/or the ear canal of the right ear 518 of the user 504. In response to the interaction of the ear canal 522 of the left ear 516 and/or the car canal of the right ear 518 of the user 504 with the group(s) of sound pulses (e.g., 520), a group(s) of sound response pulses (e.g., group of sound response pulses 524) can be emitted from the ear canal 522 of the left ear 516 and/or the ear canal of the right ear 518 of the user 504. In some embodiments, the microphone(s) 506 can sense the group(s) of sound response pulses (e.g., 524) emitted from the ear canal 522 of the left ear 516 and/or the ear canal of the right ear 518 of the user 504.

In certain embodiments, the authenticator component 108 can receive sound pulse information relating to the group(s) of sound pulses (e.g., 520) and sound pulse response information (e.g., sensor information relating thereto) relating to the group(s) of sound response pulses (e.g., 524) from the device 502. In some embodiments, the authenticator component 108 (e.g., employing the enrollment component 304, the evaluator component 308, the AI component 310 (e.g., trained AI-based model 320), and/or another component) can analyze the sound pulse information and the sound pulse response information. Based at least in part on the results of such analysis, the authenticator component 108 can determine a difference(s) (e.g., respective differences in respective characteristics) between the group(s) of sound pulses (e.g., 520) and the group(s) of sound response pulses (e.g., 524). Based at least in part on the difference(s) (e.g., first difference associated with the left ear 516 and/or a second difference associated with the right ear 518) between the group(s) of sound pulses (e.g., 520) and the group(s) of sound response pulses (e.g., 524), the authenticator component 108 can determine a first group of characteristics (e.g., a first ear canal signature) of the car canal 522 of the left ear 516 of the user 504 based at least in part on the first difference between the group of sound pulses 520 and the group of sound response pulses 524, wherein the first group of characteristics can comprise or can relate to a first ear canal measurement and/or one or more other characteristics of the ear canal 522 of the left ear 516 of the user 504, and/or can determine a second group of characteristics (e.g., a second ear canal signature) of the ear canal of the right ear 518 of the user 504 based at least in part on the second difference between the other group of sound pulses and the other group of sound response pulses associated with the right ear 518, wherein the second group of characteristics can comprise or can relate to a second ear canal measurement and/or one or more other characteristics of the ear canal of the right ear 518 of the user 504. As part of enrollment of the user 504, the authenticator component 108 (e.g., the enrollment component 304) can store, as stored authentication information associated with the user 504, the authentication information relating to the first group of characteristics of the ear canal 522 of the left ear 516 and/or the second group of characteristics of the ear canal of the right ear 518 of the user 504 in the data store 314.

Subsequently, when an unauthenticated user (e.g., the enrolled and/or verified user 504 or another user) attempts to authenticate with the authenticator component 108 (e.g., as being the user 504), the authenticator component 108 can emit, and/or can initiate or facilitate the emission of, a group(s) of sound pulses by the audio speaker(s) of the unauthenticated device (e.g., device 502 or other device) into the left ear and/or the right ear of the unauthenticated user, can receive sound pulse information relating to the group(s) of sound pulses and sound pulse response information relating to the group(s) of sound response pulses from the unauthenticated device, and, based at least in part on the results of analyzing such sound pulse information and sound pulse response information, can determine the respective group(s) of characteristics (e.g., respective ear canal measurement(s) and/or other respective characteristics) associated with the left ear and/or right ear associated with the unauthenticated user, in a same or similar manner as was performed during enrollment of the user 504.

In certain embodiments, the authenticator component 108 (e.g., employing the evaluator component 308, the AI component 310 (e.g., trained AI-based model 320), and/or another component) can access or retrieve the respective stored authentication information relating to one or more respective enrolled users, including the user 504, from the data store 314, and can evaluate the respective group(s) of characteristics (e.g., respective ear canal measurement(s) and/or other respective characteristics) of the left ear and/or right car associated with the unauthenticated user against the respective groups of characteristics of the respective cars of the one or more enrolled users. If, based at least in part on the evaluation results, the authenticator component 108 determines that the respective group(s) of characteristics of the left ear and/or right ear associated with the unauthenticated user does not satisfy defined match criteria (e.g., does not satisfy applicable threshold match or probability value(s), which can indicate no match or an insufficient match) with respect to the respective group(s) of characteristics of the left ear 516 and/or right ear 518 associated with the user 504 (e.g., from the stored authentication information), the authenticator component 108 can determine that the unauthenticated user cannot be authenticated as being the user 504 and/or the associated unauthenticated device cannot be authenticated as being the device 502. If, instead, based at least in part on the evaluation results, the authenticator component 108 determines that the respective group(s) of characteristics of the left ear and/or right car associated with the unauthenticated user does satisfy the defined match criteria (e.g., docs satisfy the applicable threshold match or probability value(s), which can indicate a match, or a substantial or sufficient match) with respect to the respective group(s) of characteristics of the left ear 516 and/or right ear 518 associated with the user 504 (e.g., does satisfy the applicable threshold match or probability value if only one ear is evaluated; or does satisfy both applicable threshold match or probability values if both cars are evaluated), the authenticator component 108 can determine that the unauthenticated user can be authenticated as being the user 504 and/or the associated unauthenticated device can be authenticated as being the device 502.

In some embodiments, the authenticator component 108 can employ a particular threshold match or probability value when only one ear (e.g., only one ear canal of one car) of a user is being evaluated. In certain embodiments, when both ear canals of both cars of a user are being evaluated, the authenticator component 108 can employ a first threshold match or probability value for the left ear and a second threshold match or probability value for the right car, in accordance with the defined authentication management criteria, wherein the first threshold match or probability value can be same as or different than the second threshold match or probability value. Due to the unicity and/or asymmetry between the left and right car canals of a user, which can be unique to that user, the first threshold match or probability value and the second threshold match or probability value typically can be relatively lower than the particular threshold match or probability value employed when only one ear of a user is being evaluated, since it can be significantly less likely that the left and right ear canals of another user are going to have the same or substantially similar respective characteristics as the left and right ear canals of the user, whereas the likelihood that one ear canal of another user can have same or similar characteristics as a corresponding ear canal of the user can be somewhat higher (although it still can be a relatively lower likelihood).

With further regard to bone conduction signatures associated with users, in some embodiments, during enrollment of the user 504, the authenticator component 108 can receive first bone conduction-related authentication information associated with the left car 516 of the user 504 and second bone conduction-related authentication information associated with the right ear 518 of the user 504 from the device 502. For instance, the one or more sensors (e.g., 508 and/or 510), which can sense bone vibration or conduction activity associated with the user 504, can sense respective bone vibration or conduction activity(ies) (e.g., vibrations and/or sounds) that can result from (e.g., can be generated as a result of) the group(s) of sound pulses (e.g., 520) emitted into the left ear 516 and/or right ear 518 of the user 504, words spoken by the user 504, or respective taps or interactions on the respective left and/or right earbuds (e.g., the left and/or right casings associated with the left audio speaker 512 and/or right audio speaker 514) of the device 502, and can generate the first bone conduction-related authentication information and/or the second bone conduction-related authentication information based at least in part on the sensed respective bone vibration or conduction activity(ies).

In certain embodiments, the authenticator component 108 (e.g., employing the enrollment component 304, the evaluator component 308, the AI component 310 (e.g., trained AI-based model 320), and/or another component) can analyze the first bone conduction-related authentication information and/or the second bone conduction-related authentication information. In some embodiments, based at least in part on the results of such analysis, the authenticator component 108 can determine a first bone conduction signature associated with the left ear 516 of the user 504 and/or a second bone conduction signature associated with the right ear 518 of the user 504. The authenticator component 108 (e.g., the enrollment component 304) can store, as stored authentication information associated with the user 504, the first bone conduction-related authentication information, the first bone conduction signature, the second bone conduction-related authentication information, and/or the second bone conduction signature associated with the user 504 in the data store 314 (along with other respective stored authentication information associated with other enrolled and/or verified users).

Subsequently, when an unauthenticated user (e.g., the enrolled and/or verified user 504 or another user) attempts to authenticate with the authenticator component 108 (e.g., as being the user 504), the authenticator component 108 can receive left bone conduction-related authentication information associated with the left ear of the unauthenticated user and/or right bone conduction-related authentication information associated with the right car of the unauthenticated user from the unauthenticated device. In certain embodiments, the left and/or right bone conduction-related authentication information can be generated by the unauthenticated device (e.g., using bone vibration or conduction sensors) in a same or similar manner as the first and/or second bone conduction-related authentication information had been generated with respect to the user 504 (e.g., in response to a group(s) of sound pulses, words spoken by the unauthenticated user, or tapping or interaction with the left and/or right earbuds of the unauthenticated device).

In some embodiments, the authenticator component 108 (e.g., employing the evaluator component 308, the AI component 310 (e.g., trained AI-based model 320), and/or another component) can analyze the left bone conduction-related authentication information and/or the right bone conduction-related authentication information. In certain embodiments, based at least in part on the results of such analysis, the authenticator component 108 can determine a left bone conduction signature associated with the left ear of the unauthenticated user and/or a right bone conduction signature associated with the right ear of the unauthenticated user. The authenticator component 108 (e.g., employing the evaluator component 308, the AI component 310 (e.g., trained AI-based model 320), and/or another component) can access or retrieve, from the data store 314, the stored authentication information associated with the user 504 and/or other stored authentication information associated with other enrolled users. In some embodiments, the authenticator component 108 (e.g., employing the evaluator component 308, the AI component 310 (e.g., trained AI-based model 320), and/or another component) can evaluate the stored authentication information associated with the user 504 (e.g., the first bone conduction-related authentication information, the first bone conduction signature, the second bone conduction-related authentication information, and/or the second bone conduction signature associated with the user 504) and the left bone conduction-related authentication information, the left bone conduction signature, the right bone conduction-related authentication information, and/or the right bone conduction signature associated with the unauthenticated user.

If, based at least in part on the evaluation results, the authenticator component 108 determines that the left bone conduction-related authentication information and/or the left bone conduction signature does not satisfy defined match criteria (e.g., does not satisfy applicable threshold match or probability value(s), which can indicate no match or an insufficient match) with respect to the first bone conduction-related authentication information and/or the first bone conduction signature associated with the user 504, and/or determines that the right bone conduction-related authentication information and/or the right bone conduction signature does not satisfy the defined match criteria with respect to the second bone conduction-related authentication information and/or the second bone conduction signature associated with the user 504, the authenticator component 108 can determine that the unauthenticated user cannot be authenticated as being the user 504 and/or the associated unauthenticated device cannot be authenticated as being the device 502. If, instead, based at least in part on the evaluation results, the authenticator component 108 determines that the left bone conduction-related authentication information and/or the left bone conduction signature does satisfy defined match criteria (e.g., does satisfy applicable threshold match or probability value(s), which can indicate a match, or a substantial or sufficient match) with respect to the first bone conduction-related authentication information and/or the first bone conduction signature associated with the user 504, and/or determines that the right bone conduction-related authentication information and/or the right bone conduction signature does satisfy the defined match criteria with respect to the second bone conduction-related authentication information and/or the second bone conduction signature associated with the user 504 (e.g., does satisfy the applicable threshold match or probability value if only one ear is evaluated; or does satisfy both applicable threshold match or probability values if both cars are evaluated), the authenticator component 108 can determine that the unauthenticated user can be authenticated as being the user 504 and/or the associated unauthenticated device can be authenticated as being the device 502.

Due to the unicity and/or asymmetry between the bone conduction of the left car and the bone conduction of the right ear of a user, which can be unique to that user, the first threshold match or probability value and the second threshold match or probability value typically can be relatively lower than a specified threshold match or probability value that may be employed when only bone conduction of one ear of a user is being evaluated, since it can be significantly less likely that a bone conduction signature of a left ear and a bone conduction signature of a right ear of another user are going to the same or substantially similar to the bone conduction signature of the left ear 516 and the bone conduction signature of the right ear 518 of the user 504, whereas the likelihood that the bone conduction signature of one ear of another user can be the same or substantially similar as a bone conduction signature of one ear of the user can be somewhat higher (although it still can be a relatively lower likelihood). It is to be appreciated and understood that the threshold match or probability values that can be applied with regard to such enhanced ear bone conduction-related authentication techniques can be different from or same as the threshold match or probability values that can be applied with regard to the enhanced ear characteristics (e.g., car auditory canal measurement) techniques, in accordance with the defined authentication management criteria.

With further regard to the AI component 310, the AI component 310 and/or the model(s) 320 (e.g., AI-based model(s), such as an automatic speaker verification (ASV) model(s)) can perform an AI-based analysis on data, such as information relating to audio-related information (e.g., audio-related authentication information), bone vibration or conduction-related information (e.g., bone vibration or conduction-related authentication information), body gesture-related information (e.g., body gesture-related authentication information), communication sessions, applications, services, attributes, conditions, characteristics, operations, functions, parameters, events, and/or other features associated with the device 102, the user 104, other users, the device 106, other devices, the authenticator component 108, and/or feedback information (e.g., feedback information from a user, a device, or another data source). In some embodiments, with regard to a model 320, the AI component 310 can input such information into the (trained) model 320 for analysis (e.g., AI-based analysis) by the model 320 to train or update the model 320 or to generate AI-based output result data based at least in part on the analysis of the input information.

In connection with or as part of such an AI-based analysis, the AI component 310 can employ, build (e.g., construct or create), and/or import, AI-based techniques and algorithms, AI-based models (e.g., untrained or trained models), neural networks (e.g., untrained or trained neural networks, which can include a time delay neural network (TDNN), deep neural network (DNN), recurrent neural network (RNN), long short-term memory (LSTM)-type neural network, gated recurrent unit (GRU)-type neural network, or other type of neural network), decision trees, Markov chains (e.g., trained Markov chains), support vector machines (SVMs), and/or graph mining to render and/or generate predictions, inferences, calculations, prognostications, estimates, derivations, forecasts, detections, and/or computations that can facilitate determining or learning data patterns in data, determining or learning a correlation, relationship, or causation between an item(s) of data and another item(s) of data (e.g., occurrence of the other item(s) of data or an event relating thereto), determining or learning a correlation, relationship, or causation between an event and another event (e.g., occurrence of another event), determining or learning about relationships between components or functions of or associated with the system (e.g., 100 or 300), determining or learning characteristics, features, and/or vectors (e.g., i-vectors, r-vectors, x-vectors, and/or other types of vectors) relating to the sensor data (e.g., audio-related information, bone vibration or conduction-related information, body gesture-related information, and/or other sensor data), determining whether authentication information (e.g., audio-related authentication information, bone vibration or conduction-related authentication information, body gesture-related authentication information, and/or other authentication information) associated with an unauthenticated user satisfies the defined match criteria with respect to stored authentication information (e.g., stored audio-related authentication information, stored bone vibration or conduction-related authentication information, stored body gesture-related authentication information, and/or other stored authentication information) associated with a verified (e.g., enrolled) user, determining whether to authenticate a user (e.g., user 104 or another user) as being a verified user and/or an associate device (e.g., device 102 or another device) as being a verified device, performing other desired functions or operations, and/or automating one or more functions or features of the disclosed subject matter, as more fully described herein.

The AI component 310 can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein with regard to the disclosed subject matter, the AI component 310 can examine the entirety or a subset of the data (e.g., sensor data; authentication information; stored authentication information; model training data; feedback or backpropagation information; and/or other information, such as described herein) to which it is granted access and can provide for reasoning about or determine states of the system and/or environment from a set of observations as captured via events and/or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events and/or data.

Such determinations can result in the construction of new events or actions from a set of observed events and/or stored event data, whether or not the events are correlated in close temporal proximity, and whether the events and data come from one or several event and data sources. In certain embodiments, components (e.g., the AI component 310, the model(s) 320, and/or another component) disclosed herein can employ various classification (explicitly trained (e.g., via training data) as well as implicitly trained (e.g., via observing behavior, preferences, historical information, receiving extrinsic information, and so on)) schemes and/or systems (e.g., SVMs, neural networks, expert systems, Bayesian belief networks, fuzzy logic, data fusion engines, and so on) in connection with performing automatic and/or determined action in connection with the claimed subject matter. Thus, classification schemes and/or systems can be used to automatically learn and perform a number of functions, actions, and/or determinations.

In some embodiments, the AI component 310 can employ a classifier that can perform an AI-based analysis on data. A classifier can map an input attribute vector, z=(z1, z2, z3, z4, . . . , zn), to a confidence that the input belongs to a class, as by f(z)=confidence (class). Such classification can employ a probabilistic and/or statistical-based analysis (e.g., factoring into the analysis utilities and costs) to determinate an action to be automatically performed. An SVM can be a non-limiting example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence, any of which can be employed. Classification as used herein also is inclusive of statistical regression that is utilized to develop models of priority.

In some embodiments, based at least in part on the results of performing an AI-based analysis on authentication information (e.g., audio-related authentication information, bone vibration or conduction-related authentication information, body gesture-related authentication information, and/or other authentication information) associated with an unauthenticated user and stored authentication information (e.g., stored audio-related authentication information, stored bone vibration or conduction-related authentication information, stored body gesture-related authentication information, and/or other stored authentication information) associated with a verified user (e.g., user 104), the trained model 320 can determine and/or extract a first user-specific vector (e.g., first i-vector, r-vector, x-vector, and/or other types of vectors) associated with the stored authentication information and a second user-specific vector (e.g., second i-vector, r-vector, x-vector, and/or other types of vectors) associated with the authentication information that can indicate a relationship (e.g., a vector distance) between the authentication information associated with the unauthenticated user and the stored authentication information associated with the verified user. The trained model 320 can determine whether a distance (e.g., vector distance) between the second user-specific vector and the first user-specific vector satisfies (e.g., is at or less than; or is within) a defined threshold (e.g., threshold maximum) distance (e.g., satisfies the applicable defined match criteria) that can indicate whether the second user-specific vector is close enough in distance to the first user-specific vector to be indicate a match, or at least a sufficiently close enough match, between the authentication information and the stored authentication information. If the trained model 320 determines that the distance between the second user-specific vector and the first user-specific vector satisfies the defined threshold distance, the trained model 320 can determine or infer that the authentication information satisfies the defined match criteria with respect to the stored authentication information, and the authenticator component 108 can determine that the unauthenticated user can be authenticated as being the verified user (e.g., assuming that there is no other evaluation to be performed and no other match criteria that has to be satisfied). If, instead, the trained model 320 determines that the distance between the second user-specific vector and the first user-specific vector does not satisfy (e.g., is greater than) the defined threshold distance, the trained model 320 can determine or infer that the authentication information does not satisfy the defined match criteria with respect to the stored authentication information, and the authenticator component 108 can determine that the unauthenticated user cannot be authenticated as being the verified user.

In certain other embodiments, the authenticator component 108 (e.g., the trained model 320 of the authenticator component 108) can utilize a similarity measure (e.g., cosine similarity, probabilistic linear discriminant analysis (PLDA), or other desired similarity measure to determine the level of similarity between the first user-specific vector associated with the stored authentication information and the second user-specific vector associated with the authentication information to facilitate determining whether the unauthenticated user can be authenticated as being the verified user (e.g., user 104). For example, based at least in part on the results of performing an AI-based analysis on the authentication information associated with the unauthenticated user and the stored authentication information associated with the verified user, the trained model 320 can determine the cosine similarity (cos(θ)) between the first user-specific vector (A) associated with the stored authentication information and the second user-specific vector (B) associated with the authentication information, in accordance with the following example equation:

$$cos ( θ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}}$$

for i=1 to n, wherein the denominator of the example equation can be a normalizing factor, and wherein, it is to be appreciated and understood that another equation term (e.g., square root of embedding/vector dimension or another desired equation term) can be utilized in the denominator of the equation, if desired.

If the trained model 320 determines that the cosine similarity value (cos(θ)) satisfies (e.g., is at or greater than; or meets or exceeds) a defined threshold cosine similarity value (e.g., as indicated or specified by the defined match criteria), the trained model 320 can determine or infer that the second user-specific vector, and accordingly, the authentication information, satisfies the defined match criteria with respect to the first user-specific vector, and accordingly, the stored authentication information, and the authenticator component 108 can determine that the unauthenticated user can be authenticated as being the verified user (e.g., assuming that there is no other evaluation to be performed and no other match criteria that has to be satisfied). If, instead, the trained model 320 determines that the distance between the second user-specific vector and the first user-specific vector does not satisfy (e.g., is less than) the defined threshold cosine similarity value, the trained model 320 can determine or infer that the second user-specific vector, and accordingly, the authentication information, does not satisfy the defined match criteria with respect to the first user-specific vector, and accordingly, the stored authentication information, and the authenticator component 108 can determine that the unauthenticated user cannot be authenticated as being the verified user.

In some embodiments, the authenticator component 108 (e.g., the AI component 310 of the authenticator component 108) can train and employ a neural network model (e.g., TDNN or other type of neural network model) for authentication. In certain embodiments, the AI component 310 can perform feature extraction and generate a short-time Fourier transform (STFT), a Mel spectrogram, Mel-frequency cepstral coefficients (MFCCs), or other type of representation of the features (e.g., representation of spectral characteristics and/or other characteristics) of sensor data relating to a user(s) (e.g., audio-related authentication information, bone vibration or conduction-related authentication information, or other type of authentication information) (or training data, if the model is being trained), based at least in part on the results of analyzing the sensor data (or training data). In some embodiments, the AI component 310 can input the information relating to the extracted features (e.g., STFT, Mel spectrogram, MFCCs, or other type of feature representation), in a desired format (e.g., suitable, usable, or compatible format), into the neural network model for AI-based analysis and/or training (e.g., if the trainer component 318 is training the neural network model). In certain embodiments, the neural network model can model long-term temporal dependencies associated with the sensor data (or training data). In some embodiments, the model (e.g., TDNN model) can employ a feed forward network, which can enable desirable (e.g., suitable, efficient, or optimal) training of the model, as compared to certain other types of recurrent networks (e.g., RNN, LSTM, or GRU), and can provide desirable performance in a variety of speech processing fields. In certain embodiments, each time context output can be equal to one user embedding (e.g., x-vector or other type of vector), and embedding for a whole utterance of a user can be equal to a pooling of the output vectors of the model, wherein the longer the speech utterance of the user, the more accurate the embedding typically can be.

In accordance with various embodiments, the authenticator component 108 (e.g., the AI component 310 and model 320 of the authenticator component 108) can desirably employ fusion of multiple modalities (e.g., audio-related authentication information, bone vibration or conduction-related authentication information, and/or other type of authentication information) in using the model to perform AI-based analysis on data (e.g., authentication information) and make determinations and inferences relating to authentication of users and/or devices. As some non-limiting examples, as part of the modality fusion, the authenticator component 108 (e.g., the AI component 310 and model 320 of the authenticator component 108) can employ vertical stacking of features (e.g., input features fusion via vertical stacking of features) during training of the model 320 and AI-based analysis and inference by the model 320, horizontal stacking of features, feature swapping, and/or separating the encoders of the model 320, such as described herein.

In some embodiments, as part of the modality fusion, the authenticator component 108 (e.g., the AI component 310 and model 320 of the authenticator component 108) can employ the vertical stacking of features (e.g., time-aligned extracted features of different modalities) to construct the fused input features associated with the user (e.g., speech or other sounds associated with the user), wherein the audio-related features extracted from the audio-related information (e.g., audio-related authentication information) associated with the user and the bone vibration or conduction-related features extracted from the bone vibration or conduction-related information (e.g., bone vibration or conduction-related authentication information) associated with the user can be vertically stacked (e.g., via vertical frequency stacking) in relation to each other (e.g., for one or more users). The AI component 310 can input the fused information relating to the vertically stacked and fused features into the model 320 to train the model 320 (if during the training of the model 320) or to perform an AI-based analysis on the fused information relating to the vertically stacked and fused features and generate one or more inferences (e.g., relating to authentication of a user) based at least in part on the results of the AI-based analysis. In certain embodiments, the model 320 can comprise one-dimensional (1-D) convolution kernels. For instance, as the 1-D convolution kernels pass through the fused input features associated with the user, on top of extracting other user-specific patterns from local neighborhoods of each modality, the authenticator component 108 (e.g., the AI component 310, the model 320, and/or other component of the authenticator component 108) can simultaneously (e.g., concurrently) learn cross-modality transfer functions, which, in turn, can aid the model 320 to more effectively recognize the respective speech and/or respective sounds of users.

In certain embodiments, as part of employing the modality fusion using vertical stacking of features, the authenticator component 108 (e.g., the AI component 310, the model 320, and/or other component of the authenticator component 108) can determine (e.g., calculate) a STFT of an input audio signal, comprising speech or sounds of the user, by dividing the input audio signal into overlapping segments and computing the Fourier transform for each segment, which can result in a time-frequency representation of the signal. For example, the authenticator component 108 can determine the STFT of a desired number of samples (e.g., 400 samples, which can correspond to 25 milliseconds (ms), or other desired number of samples higher or lower than 400) of the input audio signal using a desired window length (e.g., 25 ms, or other desired window length higher or lower than 25 ms) and a desired hope length (e.g., 10 ms, or other desired hop length higher or lower than 10 ms). In some embodiments, the authenticator component 108 can further compress this two-dimensional (2-D) feature vector by applying a set of overlapping triangular Mel filter banks to the frequency axis (e.g., y-axis) and taking (e.g., deriving) the logarithm of the filter responses. The application of the triangular Mel filter banks can reduce the frequency bins (e.g., obtained from the STFT operation) to a desired number (e.g., 80, or other desired number of bins higher or lower than 80), which can produce a Mel spectrogram of the input audio signal. The authenticator component 108 (or other component or entity associated therewith) can design (e.g., structure) the Mel filters to match or at least substantially match human auditory perception where they can be more densely packed at lower frequencies and more spread out at higher frequencies.

In some embodiments, the authenticator component 108 (e.g., the AI component 310, the model 320, and/or other component of the authenticator component 108) can reduce the Mel spectrogram into a relatively small number of coefficients that can capture the most significant features of the sound of the user. In certain embodiments, the authenticator component 108 can subject the log-amplitude values from the Mel spectrogram to a discrete cosine transform (DCT). This transform can decorrelate the Mel-frequency bins and concentrate the energy of the audio signal into a few coefficients known as MFCCs. For instance, let X_{b}(t) and Xₐ(t) represent the time-aligned bone-conducted and air-conducted speech signals of the user, respectively, indexed by a time frame t. In some embodiments, the authenticator component 108 can extract the MFCCs from each modality (e.g., bone-conducted modality and air-conducted modality), which can be denoted by M_{b}∈R^{m×T} for the bone-conducted speech and Mₐ∈R^{n×T} for the air-conducted speech of the user, where m and n can be the feature dimensions, and T can be the total number of time frames. In certain embodiments, to fuse the bone-conducted modality and the air-conducted modality, the authenticator component 108 can vertically concatenate the feature vectors from each modality for each time frame, which can form a new fused feature vector M_{f}∈R^{(m+n)×T}:

$${M}_{f} = [ \begin{matrix}{M}_{b} \\ {M}_{a}\end{matrix} ] .$$

In some embodiments, the authenticator component 108 (e.g., the AI component 310, the model(s) 320, and/or other component of the authenticator component 108) can utilize the concatenated feature vector M_{f} as input to the model(s) 320 (e.g., speaker recognition fusion model(s)) for AI-based analysis by the model(s) 320, training of the model(s) 320, and/or user verification and authentication determinations or inferences by the model(s) 320.

In certain embodiments, as part of the modality fusion, the authenticator component 108 (e.g., the AI component 310 and model 320 of the authenticator component 108) can employ the horizontal stacking of features, wherein the audio-related features extracted from the audio-related information (e.g., audio-related authentication information) associated with the user and the bone vibration or conduction-related features extracted from the bone vibration or conduction-related information (e.g., bone vibration or conduction-related authentication information) associated with the user can be horizontally stacked in relation to each other along the time axis (e.g., for one or more users). In some embodiments, in order to prevent creating artificial neighborhoods between the modalities (e.g., audio-related modality and bone vibration or conduction-related modality), and to maintain desirable consistency across all of the data samples, the AI component 310 can insert a desired number (e.g., two, four, or other desired number) of zero-feature columns between the modalities in the horizontal stack along the time axis. In certain embodiments, the AI component 310 can input the fused information relating to the horizontally stacked and fused features (and the zero-feature columns) into the model 320 to train the model 320 (if during the training of the model 320) or to perform an AI-based analysis on the fused information relating to the horizontally stacked and fused features and generate one or more inferences (e.g., relating to authentication of a user) based at least in part on the results of the AI-based analysis.

In some embodiments, as part of the modality fusion, the authenticator component 108 (e.g., the AI component 310 and model 320 of the authenticator component 108) can employ a swapping of some of the respective features associated with the respective modalities (e.g., audio-related modality and bone vibration or conduction-related modality). For instance, the AI component 310 can swap (e.g., exchange or switch out and replace) certain lower frequency cepstral coefficients of the air-conducted audio associated with the audio-related information with certain bone-conducted coefficients associated with the bone vibration or conduction-related information. As disclosed, while bone-conducted speech can be desirably immune or substantially immune against acoustic noise (e.g., air-conducted noise), bone-conducted speech may have a lower bandwidth than air-conducted speech. Therefore, it may be beneficial to replace the first few coefficients of air-conducted audio, instead of including all features of both modalities, to construct a smaller network that can have similar performance. In certain embodiments, the AI component 310 can input the fused information relating to the fused and swapped features into the model 320 to train the model 320 (if during the training of the model 320) or to perform an AI-based analysis on the fused information relating to the fused and swapped features and generate one or more inferences (e.g., relating to authentication of a user) based at least in part on the results of the AI-based analysis.

In some embodiments, as part of the modality fusion, the authenticator component 108 (e.g., the AI component 310 and model 320 of the authenticator component 108) can employ another type swapping (e.g., delta-related swapping) of some of the respective features associated with the respective modalities (e.g., audio-related modality and bone vibration or conduction-related modality). For instance, the AI component 310 can swap (e.g., exchange or switch out and replace) certain lower frequency cepstral coefficients of the air-conducted audio (e.g., associated with the audio-related information) with the delta between the air-conducted coefficients and the bone-conducted coefficients (e.g., associated with the bone vibration or conduction-related information). The rationale for doing this can be somewhat similar to that of the other disclosed swapping technique, with the difference being that this delta-related swapping technique can be utilized to directly force certain cross-modality transfer functions (e.g., relating to certain vowels). By determining (e.g., calculating) the delta (e.g., by the AI component 310 or other component of or associated with the authenticator component 108) between the two modalities, the AI component 310 (or other component) can directly provide the desired cross-modality transfer functions between the low frequency coefficients, instead of either one separately. In certain embodiments, the AI component 310 can input the fused information relating to the fused and swapped (e.g., delta swapped) features into the model 320 to train the model 320 (if during the training of the model 320) or to perform an AI-based analysis on the fused information relating to the fused and swapped features and generate one or more inferences (e.g., relating to authentication of a user) based at least in part on the results of the AI-based analysis.

In certain other embodiments, as part of the modality fusion, the authenticator component 108 (e.g., the AI component 310 and model 320 of the authenticator component 108) can separate the encoders of the model 320. It may be beneficial to separate the encoders of the model 320 to be able to train (e.g., by the trainer component 318) specialized (e.g., customized) encoders for each of the multiple modalities (e.g., audio-related modality, bone vibration or conduction-related modality, and/or other modality) and fuse the respective output embeddings from the respective specialized encoders to construct fused output embeddings, instead of having fused input features. In this arrangement, each modality can have a separate encoder (e.g., TDNN-based encoder, such as an emphasized channel attention, propagation, and aggregation (ECAPA)-TDNN-based encoder), which can output its own output embedding associated with a user(s). In some embodiments, the AI component 310 can input the respective information relating to the respective features associated with the respective modalities (e.g., audio-related modality and bone vibration or conduction-related modality) into the respective encoders of the model 320 to train the model 320 (if during the training of the model 320) or to perform an AI-based analysis on the respective information relating to the respective features associated with the respective modalities and generate one or more inferences (e.g., relating to authentication of a user) based at least in part on the results of the AI-based analysis. In certain embodiments, as part of the AI-based analysis, the respective encoders of the model 320 can determine and generate respective output embeddings based at least in part on the respective AI-based analyses performed by the respective encoders on the respective information relating to the respective features associated with the respective modalities. In some embodiments, the model 320 and/or AI component 310 can concatenate the respective output embeddings of the respective encoders, and the model 320 can input the fused and concatenated output embeddings into the classification head of the model 320 for further AI-based analysis as part of model training or to generate AI-based output results (e.g., inference(s) relating to authentication of a user, and/or another inference or AI-based output result).

With further regard to the processor component 312 described herein, the processor component 312 can work in conjunction with the other components (e.g., authentication manager component 302, enrollment component 304, segmenter component 306, evaluator component 308, AI component 310, data store 314, sensor component 112, audio generator component 118, audio interface component 120, and/or other components) to facilitate performing the various functions of the authenticator component 108 and the systems (e.g., system 100, system 500, or another system) described herein. The processor component 312 can employ one or more processors (e.g., CPUs), microprocessors, controllers, or microcontrollers that can process data, such as information relating to users, devices, sensor data, authentication information, AI-based models or functions, parameter values, instructions, code, policies and rules, defined match criteria, traffic flows, signaling, algorithms (e.g., enhanced authentication algorithms, enhanced AI-based algorithms, or other algorithms, as disclosed, defined, recited, or indicated herein by the methods, systems, and techniques described herein), protocols, interfaces, tools, and/or other information, to facilitate operation of the authenticator component 108 and/or the system (e.g., system 100, system 500, or another system), as more fully disclosed herein, and control data or signal flow between the respective electronic components of the authenticator component 108 and/or the system described herein, and/or between the electronic components of the authenticator component 108 and/or the system and other electronic components or devices (e.g., the device 102 or other devices, sensor components, or other components) associated with the system, and/or between the electronic components of the authenticator component 108 and/or the system and/or applications or services associated with the system.

With further regard to the data store 314, the data store 314 can store data structures (e.g., user data, metadata), code structure(s) (e.g., modules, objects, hashes, classes, procedures) or instructions, information relating to users, devices, sensor data, authentication information, AI-based models or functions, parameter values, instructions, code, policies and rules, defined match criteria, traffic flows, signaling, algorithms (e.g., enhanced authentication algorithms, enhanced AI-based algorithms, or other algorithms, as disclosed, defined, recited, or indicated herein by the methods, systems, and techniques described herein), protocols, interfaces, tools, and/or other information, to facilitate controlling operations associated with the authenticator component 108 and/or the system (e.g., system 100, system 500, or another system). In an aspect, the processor component 312 can be functionally coupled (e.g., through a memory bus) to the data store 314 in order to store and retrieve information desired to operate and/or confer functionality, at least in part, to the authenticator component 108 and/or the system (e.g., system 100, system 500, or another system) and their respective components, and the data store 314, and/or substantially any other operational aspects of the authenticator component 108 and/or the system.

It should be appreciated that the data store 314 can comprise volatile memory and/or nonvolatile memory. By way of example and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which can act as external cache memory. By way of example and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects are intended to comprise, without being limited to, these and other suitable types of memory.

In accordance with various embodiments, a system (e.g., system 100, system 500, or other system) as disclosed herein, electronic components of such system, and/or one or more other electronic components or other systems associated with such system, and/or electronic circuitry relating thereto, can be formed in or on one or more integrated circuits (IC), one or more IC chips, and/or one or more dies. For example, such a system as disclosed herein can be formed on a single die, or portions of such system can be formed on a desired number of dies that can be associated with (e.g., electrically connected) to each other. In some embodiments, such a system as disclosed herein, or a desired portion thereof, can be, can comprise, and/or can be formed as or part of an application-specific IC (ASIC).

The aforementioned devices and/or systems have been described with respect to interaction between several components. It should be appreciated that such systems and components can include those components or sub-components specified therein, some of the specified components or sub-components, and/or additional components. Sub-components could also be implemented as components coupled to and/or communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

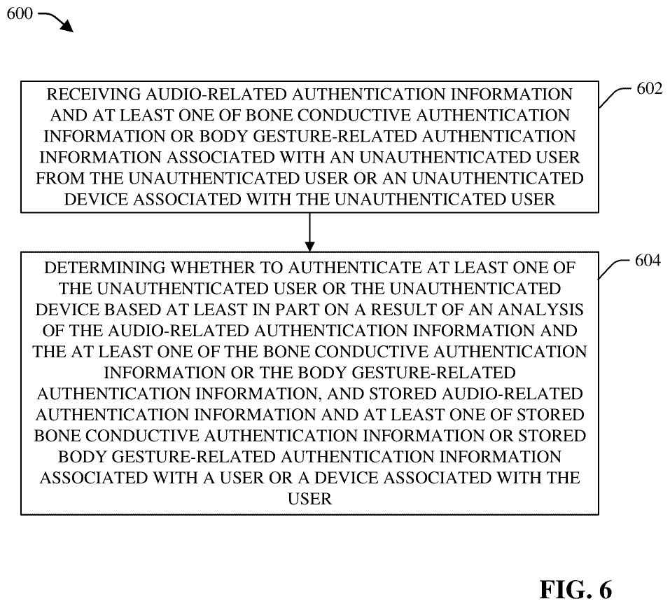

In view of the example systems and/or devices described herein, example methods that can be implemented in accordance with the disclosed subject matter can be further appreciated with reference to flowchart in FIGS. 6-10. FIGS. 6-10 illustrate methods and/or flow diagrams in accordance with the disclosed subject matter. For simplicity of explanation, the methods are depicted and described as a series of acts. It is to be understood and appreciated that the subject disclosure is not limited by the acts illustrated and/or by the order of acts, for example acts can occur in various orders and/or concurrently, and with other acts not presented and described herein. Furthermore, not all illustrated acts may be required to implement the methods in accordance with the disclosed subject matter.

Referring to FIG. 6, illustrated is a flow diagram of an example method 600 that that can desirably (e.g., suitably, accurately, efficiently, reliably, enhancedly, and/or optimally) perform and manage authentication of users (and/or associated devices) utilizing enhanced sound-related and gesture-related authentication, in accordance with various aspects and embodiments of the disclosed subject matter. The method 600 can be implemented, for example, by or utilizing a system or device comprising the authenticator component, and/or the processor and associated memory (e.g., data store).

At 602, audio-related authentication information and at least one of bone conductive authentication information or body gesture-related authentication information associated with an unauthenticated user can be received from the unauthenticated user or an unauthenticated device associated with the unauthenticated user. In some embodiments, the authenticator component can receive the audio-related authentication information and at least one of the bone conductive authentication information or the body gesture-related authentication information associated with the unauthenticated user from the unauthenticated user or the unauthenticated device associated with the unauthenticated user. The received authentication information (e.g., the audio-related authentication information and the at least one of the bone conductive (e.g., bone vibration or conduction-related) authentication information or the body gesture-related authentication information) can be generated and received from one or more of a microphone(s), sound sensor component(s), bone vibration or conduction sensor component(s), accelerometer component(s), a gyroscope component(s), IMU(s), piezo sensor component(s), and/or other type of sensor(s) associated with the unauthenticated user or unauthenticated device.

At 604, a determination can be made regarding whether to authenticate at least one of the unauthenticated user or the unauthenticated device based at least in part on a result of an analysis of the audio-related authentication information and the at least one of the bone conductive authentication information or the body gesture-related authentication information, and stored audio-related authentication information and at least one of stored bone conductive authentication information or stored body gesture-related authentication information associated with a user or a device associated with the user. In certain embodiments, the authenticator component can analyze the audio-related authentication information and the at least one of the bone conductive authentication information or the body gesture-related authentication information, and the stored audio-related authentication information and at least one of the stored bone conductive authentication information or the stored body gesture-related authentication information associated with the user (e.g., enrolled and/or verified user) or the device (e.g., verified device) (and/or other respective stored authentication information associated with other respective users and/or other respective devices). Based at least in part on the results of such analysis, the authenticator component can determine whether to authenticate at least one of the unauthenticated user or the unauthenticated device.

For example, based at least in part on the results of such analysis, the authenticator component can determine whether the received authentication information (e.g., the audio-related authentication information and the at least one of the bone conductive authentication information or the body gesture-related authentication information) satisfies defined match criteria with respect to the stored authentication information (e.g., the stored audio-related authentication information and at least one of the stored bone conductive authentication information or the stored body gesture-related authentication information). If the authenticator component determines that the received authentication information satisfies the defined match criteria (e.g., matches or substantially matches) with respect to the stored authentication information, the authenticator component can determine that the unauthenticated user can be authenticated as being the user and/or the unauthenticated device can be authenticated as being the device. If, instead, the authenticator component determines that the received authentication information does not satisfy the defined match criteria (e.g., does not match or at least substantially match) with respect to the stored authentication information, the authenticator component can determine that the unauthenticated user and/or the unauthenticated device cannot be authenticated.

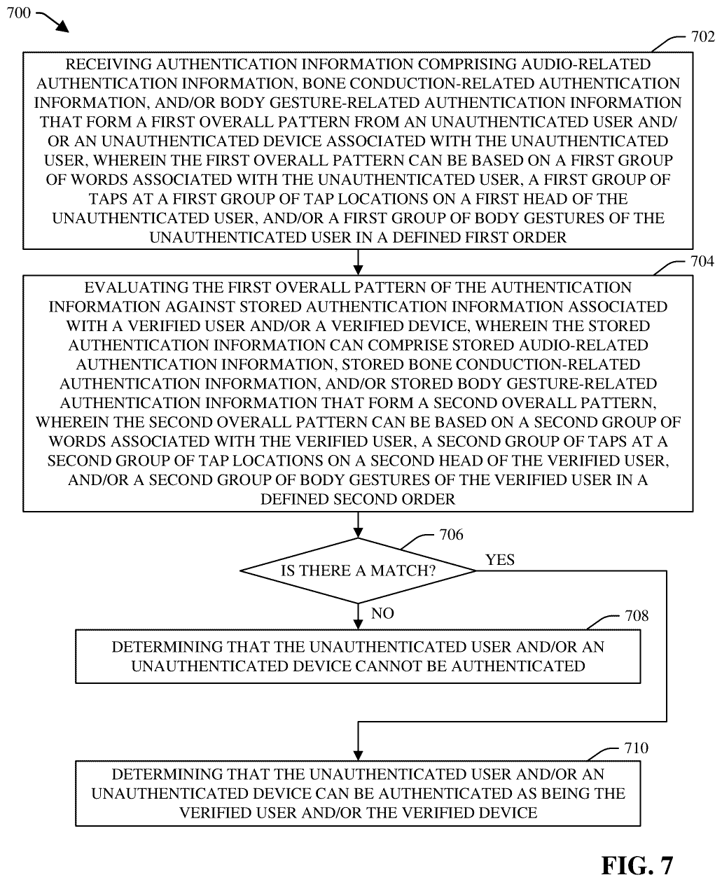

Turning to FIG. 7, FIG. 7 depicts a flow diagram of another example method 700 that can desirably (e.g., suitably, accurately, efficiently, reliably, enhancedly, and/or optimally) perform and manage authentication of users (and/or associated devices) utilizing enhanced sound-related and gesture-related authentication, in accordance with various aspects and embodiments of the disclosed subject matter. The method 700 can be implemented, for example, by or utilizing a system or device comprising the authenticator component, and/or the processor and associated memory (e.g., data store).

At 702, authentication information comprising audio-related authentication information, bone conduction-related authentication information, and/or body gesture-related authentication information that form a first overall pattern can be received from an unauthenticated user and/or an unauthenticated device associated with the unauthenticated user, wherein the first overall pattern can be based at least in part on a first group of words associated with the unauthenticated user, a first group of taps at a first group of tap locations on a first head of the unauthenticated user, and/or a first group of body gestures of the unauthenticated user in a defined first order. In certain embodiments, the authenticator component can receive the authentication information (e.g., the audio-related authentication information, the bone conduction-related authentication information (e.g., bone vibration or conduction-related authentication information), and/or the body gesture-related authentication information) from the unauthenticated user and/or the unauthenticated device. For instance, the received authentication information can be generated and received from one or more of a microphone(s), sound sensor component(s), bone vibration or conduction sensor component(s), accelerometer component(s), a gyroscope component(s), IMU(s), piezo sensor component(s), and/or other type of sensor(s) associated with the unauthenticated user or unauthenticated device.

At 704, the first overall pattern of the authentication information, comprising the audio-related authentication information, bone conduction-related authentication information, and/or body gesture-related authentication information, can be evaluated against stored authentication information associated with a verified (e.g., a verified enrolled) user and/or a verified device, wherein the stored authentication information can comprise stored audio-related authentication information, stored bone conduction-related authentication information, and/or stored body gesture-related authentication information that form a second overall pattern, wherein the second overall pattern can be based at least in part on a second group of words associated with the verified user, a second group of taps at a second group of tap locations on a second head of the verified user, and/or a second group of body gestures of the verified user in a defined second order. In some embodiments, the authenticator component can evaluate (e.g., analyze, compare, or otherwise evaluate) the received authentication information (e.g., the first overall pattern of the received authentication information in the defined first order) associated with the unauthenticated user and/or unauthenticated device against the stored authentication information (e.g., the second overall pattern of the stored authentication information in the defined second order) associated with the verified user (e.g., enrolled and/or registered user) and/or verified device (and/or other respective stored authentication information associated with other respective verified users and/or other respective verified devices), wherein the authenticator component can access and/or retrieve the stored authentication information from the data store.

At 706, based at least in part on the results of the evaluation, a determination can be made regarding whether the first overall pattern of the authentication information satisfies defined match criteria with respect to the second overall pattern of the stored authentication information. For instance, based at least in part on the evaluation results, the authentication component can determine whether the first overall pattern of the authentication information satisfies the defined match criteria with respect to the second overall pattern of the stored authentication information.

If, based at least in part on the results of the evaluation, it is determined that the first overall pattern of the authentication information does not satisfy the defined match criteria with respect to the second overall pattern of the stored authentication information, at 708, a determination can be made that the unauthenticated user and/or the unauthenticated device cannot be authenticated. In some embodiments, if, based at least in part on the evaluation results, the authenticator component determines that the first overall pattern of the authentication information does not satisfy the defined match criteria with respect to the second overall pattern of the stored authentication information, the authenticator component can determine that the unauthenticated user and/or unauthenticated device cannot be authenticated, and can decline (e.g., refuse) to authenticate the unauthenticated user and/or unauthenticated device.

Referring again to reference numeral 706, if, instead, at reference numeral 706, based at least in part on the results of the evaluation, it is determined that the first overall pattern of the authentication information does satisfy the defined match criteria with respect to the second overall pattern of the stored authentication information, at 710, a determination can be made that the unauthenticated user and/or an unauthenticated device can be authenticated as being the verified user and/or the verified device. In certain embodiments, if, instead, based at least in part on the evaluation results, the authenticator component determines that the first overall pattern of the authentication information does satisfy the defined match criteria with respect to the second overall pattern of the stored authentication information, the authenticator component can determine that the unauthenticated user and/or unauthenticated device can be authenticated, and can authenticate the unauthenticated user as being the verified user and/or the unauthenticated device as being the verified device.

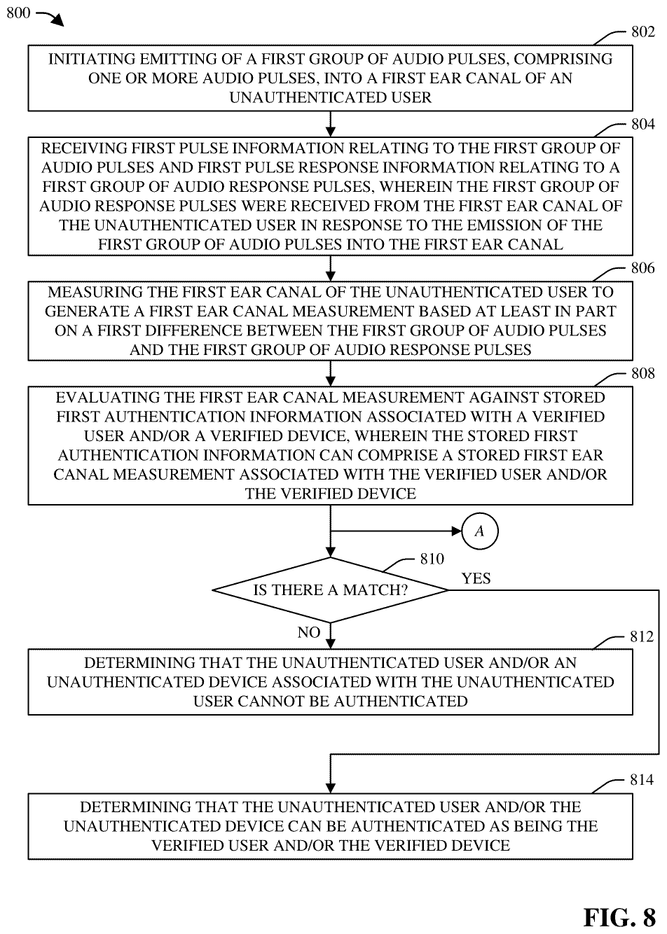

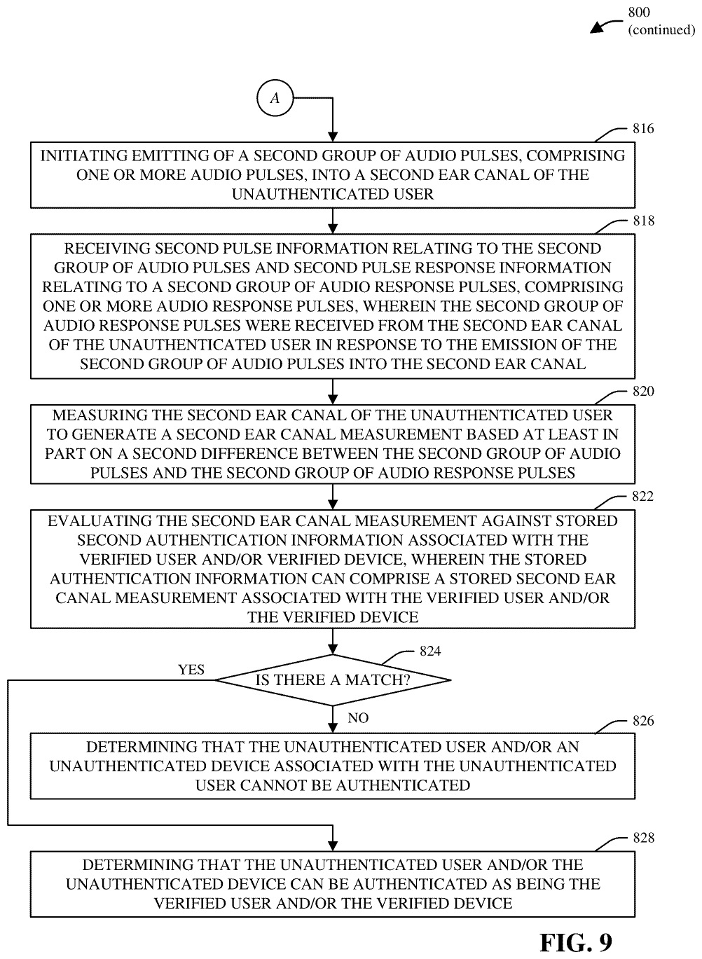

FIGS. 8 and 9 illustrate a flow diagram of an example method 800 that that can desirably (e.g., suitably, accurately, efficiently, reliably, enhancedly, and/or optimally) perform and manage authentication of users (and/or associated devices) utilizing enhanced sound-related authentication relating to ear canal measurement and/or unicity of ear canal measurements, in accordance with various aspects and embodiments of the disclosed subject matter. The method 800 can be implemented, for example, by or utilizing a system or device comprising the authenticator component, and/or the processor and associated memory (e.g., data store).

At 802, emitting of a first group of audio pulses, comprising one or more audio pulses, into a first ear canal of an unauthenticated user can be initiated. In certain embodiments, the authenticator component can initiate the emitting of the first group of audio pulses, by a first (e.g., left) audio speaker of the device associated with the unauthenticated user, into the first (e.g., left) ear canal of the unauthenticated user. For instance, the authenticator component can communicate a request to the device to have the device (e.g., employing an audio generator component) utilize the first audio speaker to emit the first group of audio pulses into the first ear canal of the unauthenticated user. In some embodiments, the first group of audio pulses can comprise one or more ultrasound or other sound pulses.

At 804, first pulse information relating to the first group of audio pulses and first pulse response information relating to a first group of audio response pulses, comprising one or more audio response pulses, can be received, wherein the first group of audio response pulses were received from the first ear canal of the unauthenticated user in response to the emission of the first group of audio pulses into the first ear canal. For instance, the microphone or other sound sensor of the device can capture, detect, or receive the first group of audio response pulses from the first ear canal of the authenticated user in response to the emission of the first group of audio pulses into the first ear canal. The authenticator component can receive the first pulse information and the first pulse response information from the device. In some embodiments, the first group of audio response pulses can comprise one or more ultrasound or other sound response pulses, wherein the first group of audio response pulses can be produced (e.g., generated or created) in response to the first group of audio pulses interacting with (e.g., bouncing off of or otherwise interacting with) the first ear canal of the unauthenticated user.

At 806, the first ear canal of the unauthenticated user can be measured to generate a first ear canal measurement based at least in part on a first difference between the first group of audio pulses and the first group of audio response pulses. In some embodiments, the authenticator component can measure the first ear canal of the unauthenticated user to generate the first ear canal measurement based at least in part on the first difference between the first group of audio pulses and the first group of audio response pulses. In certain embodiments, additionally and/or alternatively, the authenticator component can determine a first group of characteristics (e.g., a first ear canal signature) of the first ear canal of the unauthenticated user based at least in part on the first difference between the first group of audio pulses and the first group of audio response pulses, wherein the first group of characteristics can comprise or can relate to the first ear canal measurement and/or one or more other characteristics of the first ear canal.

At 808, the first ear canal measurement can be evaluated against stored first authentication information associated with a verified (e.g., an enrolled and/or registered) user and/or a verified device, wherein the stored first authentication information can comprise a stored first ear canal measurement associated with the verified user and/or the verified device (e.g., with the stored first ear canal measurement can be obtained during an enrollment process or enrollment update process). In some embodiments, the authenticator component can evaluate (e.g., compare or analyze) the first ear canal measurement against the stored first authentication information, comprising the stored first ear canal measurement, associated with the verified user and/or verified device (and/or other respective stored authentication information associated with other respective users and/or other respective devices), wherein the authenticator component can access and/or retrieve the stored first authentication information from the data store. In certain embodiments, additionally and/or alternatively, the authenticator component can evaluate the first group of characteristics of the first car canal against a stored first group of characteristics of a verified first (e.g., left) ear canal associated with the verified user.

In some embodiments, the method can proceed to reference numeral 810 followed by reference numerals 812 and 814. In other embodiments, the method 800 can proceed to reference point A, wherein the method 800 can continue from that point, such as described herein and depicted in FIG. 9.

At 810, based at least in part on the results of the evaluation, a determination can be made regarding whether the first ear canal measurement satisfies defined match criteria with respect to the stored first ear canal measurement. In certain embodiments, the authenticator component can determine whether the first ear canal measurement satisfies the defined match criteria (e.g., matches or at least sufficiently and substantially matches) with respect to the stored first ear canal measurement. In some embodiments, additionally and/or alternatively, the authenticator component can determine whether the first group of characteristics satisfy the defined match criteria with respect to the stored first group of characteristics. In some embodiments, the defined match criteria can comprise a defined threshold (e.g., minimum threshold) match or probability value that, when satisfied (e.g., met or exceeded), can indicate that the first ear canal measurement matches or at least sufficiently and substantially matches the stored first ear canal measurement, and, when not satisfied, can indicate that the first car canal measurement does not match or does not sufficiently and substantially match the stored first ear canal measurement.

If, based at least in part on the results of the evaluation, it is determined that the first car canal measurement does not satisfy the defined match criteria with respect to the stored first ear canal measurement, at 812, a determination can be made that the unauthenticated user and/or an unauthenticated device associated with the unauthenticated user cannot be authenticated. In some embodiments, if, based at least in part on the evaluation results, the authenticator component determines that the first ear canal measurement does not satisfy the defined match criteria with respect to the stored first ear canal measurement, the authenticator component can determine that the unauthenticated user and/or the unauthenticated device associated with the unauthenticated user cannot be authenticated. In certain embodiments, additionally and/or alternatively, if, based at least in part on the evaluation results, the authenticator component determines that the first group of characteristics does not satisfy the defined match criteria with respect to the stored first group of characteristics, the authenticator component can determine that the unauthenticated user and/or the unauthenticated device associated with the unauthenticated user cannot be authenticated.

Referring again to reference numeral 810, if, instead, at reference numeral 810, based at least in part on the results of the evaluation, it is determined that the first ear canal measurement does satisfy the defined match criteria with respect to the stored first ear canal measurement, at 814, a determination can be made that the unauthenticated user and/or the unauthenticated device can be authenticated as being the verified user and/or the verified device. In some embodiments, if, instead, based at least in part on the evaluation results, the authenticator component determines that the first ear canal measurement does satisfy the defined match criteria with respect to the stored first ear canal measurement, the authenticator component can determine that the unauthenticated user can be authenticated as being the verified user and/or the unauthenticated device associated with the unauthenticated user can be authenticated as being the verified device. In certain other embodiments, additionally and/or alternatively, if, based at least in part on the evaluation results, the authenticator component determines that the first group of characteristics does satisfy the defined match criteria with respect to the stored first group of characteristics, the authenticator component can determine that the unauthenticated user can be authenticated as being the verified user and/or the unauthenticated device associated with the unauthenticated user can be authenticated as being the verified device.

Referring again to reference point A, in certain embodiments, the method 800 can proceed to reference numeral 816 (e.g., the method 800 can proceed from reference numeral 808 to reference numeral 816 via reference point A, such as described herein and depicted in FIG. 9).

At 816, emitting of a second group of audio pulses, comprising one or more audio pulses, into a second ear canal of the unauthenticated user can be initiated. In some embodiments, the authenticator component can initiate the emitting of the second group of audio pulses, by a second (e.g., right) audio speaker of the device associated with the unauthenticated user, into the second (e.g., right) ear canal of the unauthenticated user. For instance, the authenticator component can communicate a request to the device to have the device (e.g., employing an audio generator component) utilize the second audio speaker to emit the second group of audio pulses into the second ear canal of the unauthenticated user. In certain embodiments, the second group of audio pulses can comprise one or more ultrasound or other sound pulses.

At 818, second pulse information relating to the second group of audio pulses and second pulse response information relating to a second group of audio response pulses, comprising one or more audio response pulses, can be received, wherein the second group of audio response pulses were received from the second ear canal of the unauthenticated user in response to the emission of the second group of audio pulses into the second ear canal. For instance, the microphone or other sound sensor of the device can capture, sense, detect, or receive the second group of audio response pulses from the second ear canal of the authenticated user in response to the emission of the second group of audio pulses into the second ear canal. The authenticator component can receive the second pulse information and the second pulse response information from the device. In some embodiments, the second group of audio response pulses can comprise one or more ultrasound or other sound response pulses, wherein the second group of audio response pulses can be produced (e.g., generated or created) in response to the second group of audio pulses interacting with (e.g., bouncing off of or otherwise interacting with) the second ear canal of the unauthenticated user.

At 820, the second ear canal of the unauthenticated user can be measured to generate a second ear canal measurement based at least in part on a second difference between the second group of audio pulses and the second group of audio response pulses. In some embodiments, the authenticator component can measure the second ear canal of the unauthenticated user to generate the second ear canal measurement based at least in part on the second difference between the second group of audio pulses and the second group of audio response pulses. In certain embodiments, additionally and/or alternatively, the authenticator component can determine a second group of characteristics (e.g., a second car canal signature) of the second ear canal of the unauthenticated user based at least in part on the second difference between the second group of audio pulses and the second group of audio response pulses, wherein the second group of characteristics can comprise or can relate to the second ear canal measurement and/or one or more other characteristics of the second car canal.

At 822, the second ear canal measurement can be evaluated against stored second authentication information associated with the verified user and/or verified device, wherein the stored authentication information can comprise a stored second ear canal measurement associated with the verified user and/or the verified device (e.g., with the stored second car canal measurement can be obtained during the enrollment process or enrollment update process). In some embodiments, the authenticator component can evaluate (e.g., compare or analyze) the second ear canal measurement against the stored second authentication information, comprising the stored second ear canal measurement, associated with the verified user and/or verified device (and/or other respective stored authentication information associated with other respective users and/or other respective devices), wherein the authenticator component can access and/or retrieve the stored second authentication information from the data store. In certain embodiments, additionally and/or alternatively, the authenticator component can evaluate the second group of characteristics of the second car canal against a stored second group of characteristics of a verified second (e.g., right) car canal associated with the verified user.

At 824, based at least in part on the results of the evaluation, a determination can be made regarding whether the first ear canal measurement satisfies the defined match criteria with respect to the stored first ear canal measurement, and whether the second ear canal measurement satisfies the defined match criteria with respect to the stored second ear canal measurement. In certain embodiments, based at least in part on the evaluation results, the authenticator component can determine whether the first ear canal measurement satisfies the defined match criteria with respect to the stored first ear canal measurement, and whether the second ear canal measurement satisfies the defined match criteria with respect to the stored second ear canal measurement. In some embodiments, additionally and/or alternatively, based at least in part on the evaluation results, the authenticator component can determine whether the first group of characteristics satisfy the defined match criteria with respect to the stored first group of characteristics, and whether the second group of characteristics satisfy the defined match criteria with respect to the stored second group of characteristics. In some embodiments, the defined match criteria can comprise a defined first threshold (e.g., minimum threshold) match or probability value that, when satisfied (e.g., met or exceeded), can indicate that the first ear canal measurement matches or at least sufficiently and substantially matches the stored first ear canal measurement, and, when not satisfied, can indicate that the first ear canal measurement does not match or does not sufficiently and substantially match the stored first ear canal measurement. The defined match criteria also can comprise a defined second threshold (e.g., minimum threshold) match or probability value that, when satisfied, can indicate that the second ear canal measurement matches or at least sufficiently and substantially matches the stored second ear canal measurement, and, when not satisfied, can indicate that the second ear canal measurement does not match or does not sufficiently and substantially match the stored second ear canal measurement, wherein the second threshold match or probability value can be same as or different from the first threshold match or probability value.

If, based at least in part on the results of the evaluation, it is determined that the first car canal measurement does not satisfy the defined match criteria with respect to the stored first ear canal measurement and/or the second ear canal measurement does not satisfy the defined match criteria with respect to the stored second ear canal measurement, at 826, a determination can be made that the unauthenticated user and/or the unauthenticated device cannot be authenticated. In some embodiments, if, based at least in part on the evaluation results, the authenticator component determines that the first ear canal measurement does not satisfy the defined match criteria with respect to the stored first ear canal measurement and/or the second ear canal measurement does not satisfy the defined match criteria with respect to the stored second ear canal measurement, the authenticator component can determine that the unauthenticated user and/or the unauthenticated device cannot be authenticated, and can decline (e.g., refuse) to authenticate the unauthenticated user and/or unauthenticated device. In certain embodiments, additionally and/or alternatively, if, based at least in part on the evaluation results, the authenticator component determines that the first group of characteristics does not satisfy the defined match criteria with respect to the stored first group of characteristics and/or the second group of characteristics does not satisfy the defined match criteria with respect to the stored group of characteristics, the authenticator component can determine that the unauthenticated user and/or the unauthenticated device cannot be authenticated, and can decline (e.g., refuse) to authenticate the unauthenticated user and/or unauthenticated device.

Referring again to reference numeral 824, if, instead, at reference numeral 824, based at least in part on the results of the evaluation, it is determined that the first ear canal measurement does satisfy the defined match criteria with respect to the stored first ear canal measurement and the second ear canal measurement does satisfy the defined match criteria with respect to the stored second ear canal measurement, at 828, a determination can be made that the unauthenticated user and/or the unauthenticated device can be authenticated as being the verified user and/or the verified device. In some embodiments, if, instead, based at least in part on the evaluation results, the authenticator component determines that the first car canal measurement does satisfy the defined match criteria with respect to the stored first car canal measurement and the second ear canal measurement does satisfy the defined match criteria with respect to the stored second ear canal measurement, the authenticator component can determine that the unauthenticated user and/or the unauthenticated device can be authenticated, and can authenticate the unauthenticated user as being the verified user and/or the unauthenticated device as being the verified device. In certain embodiments, additionally and/or alternatively, if, based at least in part on the evaluation results, the authenticator component determines that the first group of characteristics does satisfy the defined match criteria with respect to the stored first group of characteristics and the second group of characteristics does satisfy the defined match criteria with respect to the stored second group of characteristics, the authenticator component can determine that the unauthenticated user and/or the unauthenticated device can be authenticated, and can authenticate the unauthenticated user as being the verified user and/or the unauthenticated device as being the verified device.

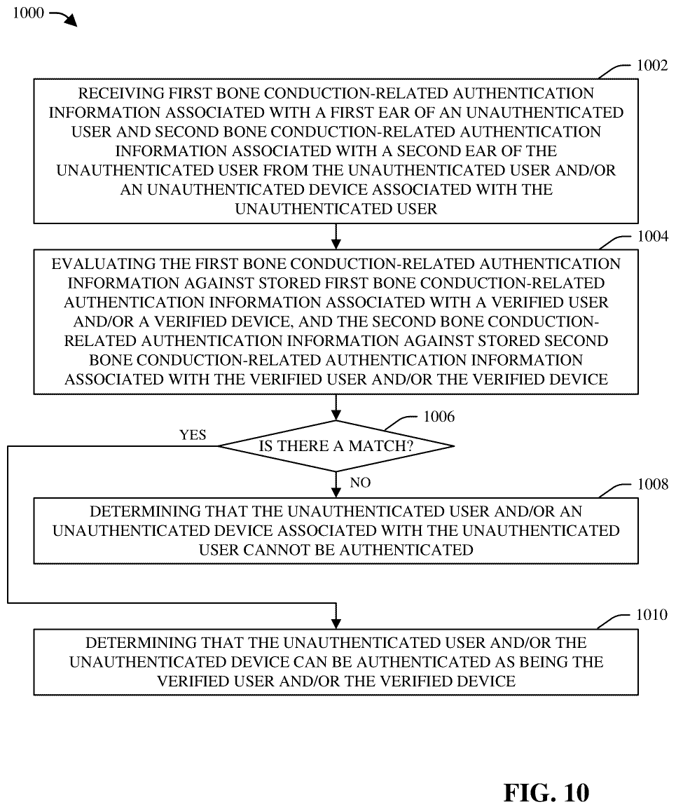

FIG. 10 depicts a flow diagram of an example method 1000 that that can desirably (e.g., suitably, accurately, efficiently, reliably, enhancedly, and/or optimally) perform and manage authentication of users (and/or associated devices) utilizing enhanced sound-related authentication relating to bone conduction characteristics associated with an ear of an unauthenticated user and/or unicity of bone conduction characteristics associated with the cars of the unauthenticated user, in accordance with various aspects and embodiments of the disclosed subject matter. The method 900 can be implemented, for example, by or utilizing a system or device comprising the authenticator component, and/or the processor and associated memory (e.g., data store).

At 1002, first bone conduction-related authentication information associated with a first ear of an unauthenticated user and second bone conduction-related authentication information associated with a second ear of the unauthenticated user can be received from the unauthenticated user and/or an unauthenticated device associated with the unauthenticated user. In some embodiments, the unauthenticated device, employing a bone vibration or conduction sensor component(s), can capture (e.g., sense or detect) or obtain the first bone conduction-related authentication information (e.g., first bone vibration or conduction-related authentication information) associated with the first (e.g., left) ear of the unauthenticated user and the second bone conduction-related authentication information associated with the second (e.g., right) ear of the unauthenticated user. In certain embodiments, the authenticator component can receive the first bone conduction-related authentication information and the second bone conduction-related authentication information from the unauthenticated device.

At 1004, the first bone conduction-related authentication information can be evaluated against stored first bone conduction-related authentication information associated with a verified (e.g., a verified enrolled) user and/or a verified device, and the second bone conduction-related authentication information can be evaluated against stored second bone conduction-related authentication information associated with the verified user and/or the verified device. In some embodiments, the authenticator component can evaluate (e.g., analyze or compare) the first bone conduction-related authentication information against the stored first bone conduction-related authentication information associated with the verified user and/or verified device, and evaluate the second bone conduction-related authentication information against the stored second bone conduction-related authentication information associated with the verified user and/or verified device (and/or against other respective stored bone conduction-related authentication information associated with other respective users and/or other respective devices).

At 1006, based at least in part on the results of the evaluation, a determination can be made regarding whether the first bone conduction-related authentication information satisfies defined match criteria with respect to the stored first bone conduction-related authentication information, and whether the second bone conduction-related authentication information satisfies the defined match criteria with respect to the stored second bone conduction-related authentication information. In some embodiments, based at least in part on the evaluation results, the authenticator component can determine whether the first bone conduction-related authentication information satisfies the defined match criteria with respect to the stored first bone conduction-related authentication information, and whether the second bone conduction-related authentication information satisfies the defined match criteria with respect to the stored second bone conduction-related authentication information.

If, based at least in part on the results of the evaluation, it is determined that the first bone conduction-related authentication information does not satisfy the defined match criteria with respect to the stored first bone conduction-related authentication information and/or the stored second bone conduction-related authentication information does not satisfy the defined match criteria with respect to the stored second bone conduction-related authentication information, at 1008, a determination can be made that the unauthenticated user and/or the unauthenticated device cannot be authenticated. In certain embodiments, if, based at least in part on the evaluation results, the authenticator component determines that the first bone conduction-related authentication information does not satisfy the defined match criteria with respect to the stored first bone conduction-related authentication information and/or the stored second bone conduction-related authentication information does not satisfy the defined match criteria with respect to the stored second bone conduction-related authentication information, the authenticator component can determine that the unauthenticated user and/or the unauthenticated device cannot be authenticated, and can decline to authenticate the unauthenticated user and/or unauthenticated device.

Referring again to reference numeral 1006, if, instead, at reference numeral 1006, based at least in part on the results of the evaluation, it is determined that the first bone conduction-related authentication information does satisfy the defined match criteria with respect to the stored first bone conduction-related authentication information and the stored second bone conduction-related authentication information does satisfy the defined match criteria with respect to the stored second bone conduction-related authentication information, at 1010, a determination can be made that the unauthenticated user and/or the unauthenticated device can be authenticated as being the verified user and/or the verified device. In some embodiments, if, instead, based at least in part on the evaluation results, the authenticator component determines that the first bone conduction-related authentication information does satisfy the defined match criteria with respect to the stored first bone conduction-related authentication information and the stored second bone conduction-related authentication information does satisfy the defined match criteria with respect to the stored second bone conduction-related authentication information, the authenticator component can determine that the unauthenticated user and/or the unauthenticated device can be authenticated, and can authenticate the unauthenticated user as being the verified user and/or the unauthenticated device as being the verified device.

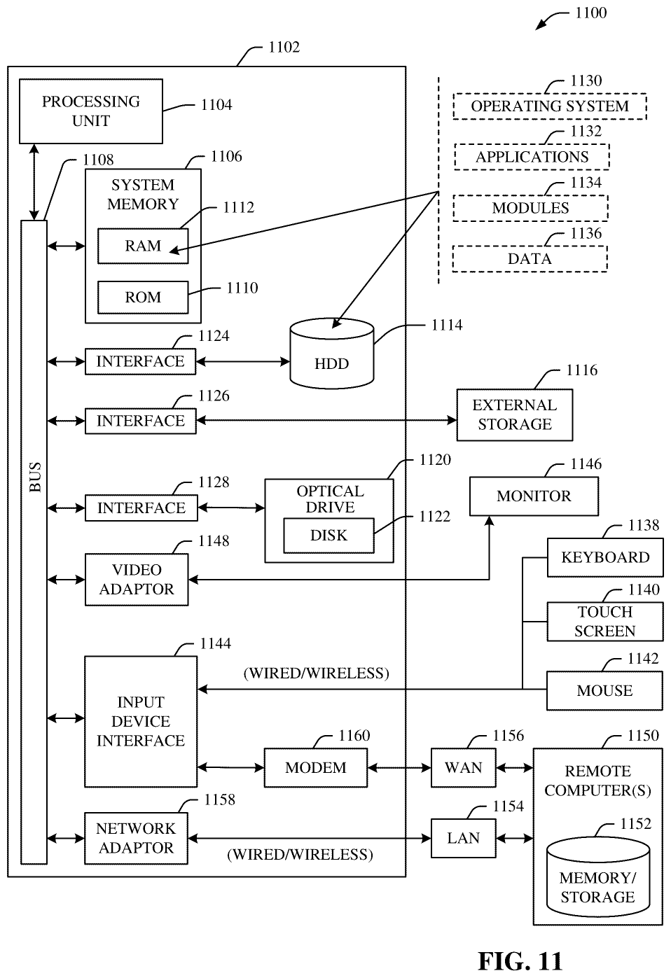

In order to provide additional context for various embodiments described herein, FIG. 11 and the following discussion are intended to provide a brief, general description of a suitable computing environment 1100 in which the various embodiments of the embodiments described herein can be implemented. While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and include any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments of the aspects described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 also can be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, or other interface.

A monitor 1146 or other type of display device can also be connected to the system bus 1108 via an interface, such as a video adapter 1148. In addition to the monitor 1146, a computer typically includes other peripheral output devices (not shown), such as speakers, printers, or other peripheral output device.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156, e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

Various aspects or features described herein can be implemented as a method, apparatus, system, or article of manufacture using standard programming or engineering techniques. In addition, various aspects or features disclosed in the subject specification can also be realized through program modules that implement at least one or more of the methods disclosed herein, the program modules being stored in a memory and executed by at least a processor. Other combinations of hardware and software or hardware and firmware can enable or implement aspects described herein, including disclosed method(s). The term “article of manufacture” as used herein is intended to encompass a computer program accessible from any computer-readable device, carrier, or storage media. For example, computer-readable storage media can include but are not limited to magnetic storage devices (e.g., hard disk, floppy disk, magnetic strips, etc.), optical discs (e.g., compact disc (CD), digital versatile disc (DVD), blu-ray disc (BD), etc.), smart cards, and memory devices comprising volatile memory and/or non-volatile memory (e.g., flash memory devices, such as, for example, card, stick, key drive, etc.), or the like. In accordance with various implementations, computer-readable storage media can be non-transitory computer-readable storage media and/or a computer-readable storage device can comprise computer-readable storage media.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. A processor can be or can comprise, for example, multiple processors that can include distributed processors or parallel processors in a single machine or multiple machines. Additionally, a processor can comprise or refer to an integrated circuit, an application specific integrated circuit (ASIC), a digital signal processor (DSP), a programmable gate array (PGA), a field programmable gate array (FPGA), a programmable logic controller (PLC), a complex programmable logic device (CPLD), a state machine, a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

A processor can facilitate performing various types of operations, for example, by executing computer-executable instructions. When a processor executes instructions to perform operations, this can include the processor performing (e.g., directly performing) the operations and/or the processor indirectly performing operations, for example, by facilitating (e.g., facilitating operation of), directing, controlling, or cooperating with one or more other devices or components to perform the operations. In some implementations, a memory can store computer-executable instructions, and a processor can be communicatively coupled to the memory, wherein the processor can access or retrieve computer-executable instructions from the memory and can facilitate execution of the computer-executable instructions to perform operations.

In certain implementations, a processor can be or can comprise one or more processors that can be utilized in supporting a virtualized computing environment or virtualized processing environment. The virtualized computing environment may support one or more virtual machines representing computers, servers, or other computing devices. In such virtualized virtual machines, components such as processors and storage devices may be virtualized or logically represented.

In the subject specification, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

As used in this application, the terms “component,” “system,” “platform,” “framework,” “layer,” “interface,” “agent,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, computer-executable instructions, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

It is to be appreciated and understood that components (e.g., authenticator component, sensor component, audio-related sensor component, bone conduction-related sensor component, body gesture-related sensor component, AI component, model, device, processor component, data store, or other component), as described with regard to a particular device, system, or method, can comprise the same or similar functionality as respective components (e.g., respectively named components or similarly named components) as described with regard to other devices, systems, or methods disclosed herein.

Although the description has been provided with respect to particular embodiments thereof, these particular embodiments are merely illustrative and not restrictive.

While particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

What has been described above includes examples of aspects of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has,” or “having,” or variations thereof, are used in either the detailed description or the claims, such terms are intended to be inclusive in a manner similar to the term “comprising” as “comprising” is interpreted when employed as a transitional word in a claim.

What is claimed is:

1. A system, comprising:
a receiver component that receives audio-related authentication information and at least one of bone conductive authentication information or body gesture-related authentication information associated with an unauthenticated user from the unauthenticated user or an unauthenticated device associated with the unauthenticated user; and
an authenticator component that determines whether to authenticate at least one of the unauthenticated user or the unauthenticated device based on a result of an analysis of the audio-related authentication information and the at least one of the bone conductive authentication information or the body gesture-related authentication information, and stored audio-related authentication information and at least one of stored bone conductive authentication information or stored body gesture-related authentication information associated with a user or a device associated with the user.

2. The system of claim 1, wherein the audio-related authentication information relates to at least one audio signal captured by a microphone associated with the unauthenticated user or the unauthenticated device, wherein the audio-related authentication information comprises at least one of sound authentication information relating to a measurement of an ear auditory canal associated with the unauthenticated user or voice authentication information associated with the unauthenticated user, and wherein the at least one of the bone conductive authentication information or the body gesture-related authentication information is part of at least one signal captured by an accelerometer component, a gyroscope component, an inertial measurement unit, a piezo sensor component, or a bone vibration or conduction sensor component associated with the unauthenticated user or the unauthenticated device.

3. The system of claim 1, wherein the bone conductive authentication information is based on a first pattern of a first group of taps at a first group of tap locations on a first head of the unauthenticated user that is captured by an accelerometer component, a gyroscope component, an inertial measurement unit, a piezo sensor component, or a bone vibration or conduction sensor component associated with the unauthenticated user or the unauthenticated device, and wherein the stored bone conductive authentication information is based on a second pattern of a second group of taps at a second group of tap locations on a second head of the user.

4. The system of claim 3, wherein at least two of the audio-related authentication information, the bone conductive authentication information, or the body gesture-related authentication information form a first overall pattern that is based on at least two of a first word associated with the unauthenticated user, the first group of taps at the first group of tap locations on the first head of the unauthenticated user, or a first body gesture of the unauthenticated user in a defined first order, wherein the first body gesture is captured by the accelerometer component, the gyroscope component, or the inertial measurement unit, and wherein at least two of the stored audio-related authentication information, the stored bone conductive authentication information, or the stored body gesture-related authentication information form a second overall pattern that is based on at least two of a second word associated with the user, the second group of taps at the second group of tap locations on the second head of the user, or a second body gesture of the user in a defined second order.

5. The system of claim 1, wherein the body gesture-related authentication information is based on a first pattern of a first group of body gestures comprising at least one of a first movement or a first position of a first body part of the unauthenticated user or the unauthenticated device in a defined first order, wherein the first pattern of the first group of body gestures is captured by an accelerometer component, an gyroscope component, or an inertial measurement unit, and wherein the stored body gesture-related authentication information is based on a second pattern of a second group of body gestures comprising at least one of a second movement or a second position of a second body part of the user or the device in a defined second order.

6. The system of claim 1, wherein the bone conductive authentication information indicates a first bone conduction of a first ear and a second bone conduction of a second ear of the unauthenticated user, and wherein the stored bone conductive authentication information indicates a third bone conduction of a third ear and a fourth bone conduction of a fourth ear of the user.

7. The system of claim 1, wherein, in response to determining, based on the result, that the audio-related authentication information and the at least one of the bone conductive authentication information or the body gesture-related authentication information satisfy defined match criteria with respect to the stored audio-related authentication information and the at least one of the stored bone conductive authentication information or the stored body gesture-related authentication information, the authenticator component determines that at least one of the unauthenticated user is authenticated as being the user or the unauthenticated device is authenticated as being the device.

8. The system of claim 1, wherein, in response to determining, based on the result, that the audio-related authentication information or the at least one of the bone conductive authentication information or the body gesture-related authentication information does not satisfy defined match criteria with respect to the stored audio-related authentication information and the at least one of the stored bone conductive authentication information or the stored body gesture-related authentication information, the authenticator component determines that at least one of the unauthenticated user is not authenticated as being the user or the unauthenticated device is not authenticated as being the device.

9. The system of claim 1, wherein the unauthenticated device is or comprises at least one of an earbud or earphone device, an electronic headset device, an electronic eyeglasses device, or an augmented reality-virtual reality headset device that comprises at least two of a microphone, a sound sensor, a bone vibration or conduction sensor component, an accelerometer component, a gyroscope component, an inertial measurement unit, a piezo sensor component, or a sound speaker.

10. A device, comprising:
a receiver component that receives at least one of bone conductive authentication information or body gesture-related authentication information associated with an unauthenticated user from the unauthenticated user or an unauthenticated device associated with the unauthenticated user; and
an authenticator component that determines whether to authenticate at least one of the unauthenticated user or the unauthenticated device based on a result of an evaluation of the at least one of the bone conductive authentication information or the body gesture-related authentication information, and at least one of stored bone conductive authentication information or stored body gesture-related authentication information associated with a verified user or a verified device associated with the verified user.

11. The device of claim 10, wherein the at least one of the bone conductive authentication information or the body gesture-related authentication information is part of at least one signal captured by an accelerometer component, a gyroscope component, an inertial measurement unit, a piezo sensor component, or a bone vibration or conduction sensor component associated with the unauthenticated user or the unauthenticated device.

12. The device of claim 10, wherein the bone conductive authentication information is based on a first pattern of a first group of taps at a first group of tap locations on a first head of the unauthenticated user that is captured by an accelerometer component, a gyroscope component, an inertial measurement unit, a piezo sensor component, or a bone vibration or conduction sensor component associated with the unauthenticated user or the unauthenticated device, and wherein the stored bone conductive authentication information is based on a second pattern of a second group of taps at a second group of tap locations on a second head of the verified user.

13. The device of claim 12, wherein the at least one of the bone conductive authentication information or the body gesture-related authentication information form a first overall pattern that is based on at least two of a first phoneme of a first word associated with the unauthenticated user, the first group of taps at the first group of tap locations on the first head of the unauthenticated user, or a first body gesture of the unauthenticated user in a defined first order, wherein the first phoneme of the first word or the first body gesture is captured by the accelerometer component, the gyroscope component, or the inertial measurement unit, and wherein at least one of the stored bone conductive authentication information or the stored body gesture-related authentication information form a second overall pattern that is based on at least two of a second phoneme of a second word associated with the verified user, the second group of taps at the second group of tap locations on the second head of the verified user, or a second body gesture of the verified user in a defined second order.

14. The device of claim 10, wherein the body gesture-related authentication information is based on a first pattern of a first group of body gestures comprising at least one of a first movement or a first position of a first body part of the unauthenticated user or the unauthenticated device in a defined first order, wherein the first pattern of the first group of body gestures is captured by an accelerometer component, an gyroscope component, or an inertial measurement unit, and wherein the stored body gesture-related authentication information is based on a second pattern of a second group of second body gestures comprising at least one of a second movement or a second position of a second body part of the user or the device in a defined second order.

15. The device of claim 10, wherein the receiver component receives an audio signal comprising the bone conductive authentication information comprising respective first words spoken by the unauthenticated user, wherein the authenticator component segments the respective first words into respective first phonemes and determines whether the respective first phonemes satisfy defined match criteria with respect to respective second phonemes of respective second words of the stored bone conductive authentication information to facilitate determining whether to authenticate the unauthenticated user or the unauthenticated device as the verified user or the verified device.

16. The device of claim 10, wherein, in response to determining, based on the result, that the at least one of the bone conductive authentication information or the body gesture-related authentication information satisfy defined match criteria with respect to the at least one of the stored bone conductive authentication information or the stored body gesture-related authentication information, the authenticator component determines that at least one of the unauthenticated user is authenticated as being the verified user or the unauthenticated device is authenticated as being the verified device; or
wherein, in response to determining, based on the result, that the at least one of the bone conductive authentication information or the body gesture-related authentication information does not satisfy defined match criteria with respect to the at least one of the stored bone conductive authentication information or the stored body gesture-related authentication information, the authenticator component determines that at least one of the unauthenticated user is not authenticated as being the verified user or the unauthenticated device is not authenticated as being the verified device.

17. The device of claim 10, wherein the unauthenticated device is or comprises at least one of an earbud or earphone device, an electronic headset device, an electronic eyeglasses device, or an augmented reality-virtual reality headset device that comprises at least two of a microphone, a sound sensor, a bone vibration or conduction sensor component, an accelerometer component, a gyroscope component, an inertial measurement unit, a piezo sensor component, or a sound speaker.

18. A method, comprising:
analyzing, by a system comprising at least one processor, audio-related authentication information associated with an unauthenticated user or an unauthenticated device, and stored audio-related authentication information associated with a verified user or a verified device associated with the verified user, wherein the audio-related authentication information is received from the unauthenticated user or the unauthenticated device associated with the unauthenticated user; and
determining, by the system, whether to authenticate at least one of the unauthenticated user or the unauthenticated device based on a result of the analyzing of the audio-related authentication information and the stored audio-related authentication information, wherein a first portion of the audio-related authentication information relates to a first interaction between a first sound signal and a first body part associated with the unauthenticated user, and wherein a second portion of the stored audio-related authentication information relates to a second interaction between a second sound signal and a second body part associated with the verified user.

19. The method of claim 18, wherein the audio-related authentication information comprises an audio response pulse or a second pattern of audio response pulses, wherein the result is a first result, and wherein the method further comprises:
initiating, by the system, emitting of an audio pulse or a first pattern of audio pulses from a speaker associated with the unauthenticated device into a first ear of the unauthenticated user, wherein the audio pulse is an ultrasound pulse or a sound pulse, and wherein the first pattern of audio pulses comprises ultrasound pulses or sound pulses;
based on the emitting, receiving, by the system, the audio response pulse or the second pattern of audio response pulses from the unauthenticated device, wherein the audio response pulse or the second pattern of audio response pulses was created based on an interaction of the audio pulse or the first pattern of audio pulses with the first ear of the unauthenticated user, and wherein the audio response pulse or the second pattern of audio response pulses was captured by a microphone associated with the unauthenticated device;
measuring, by the system, a first auditory canal of the first ear of the unauthenticated user based on a first difference between the audio response pulse and the audio pulse or based on a second difference between the second pattern of audio response pulses and the first pattern of audio pulses; and
determining, by the system, whether to authenticate the unauthenticated user as being the verified user or the unauthenticated device as being the verified device based on a second result of determining whether a measurement of the auditory canal satisfies defined match criteria with respect to a stored measurement of a second auditory canal of a second ear of the verified user.

20. The method of claim 19, wherein the audio-related authentication information further comprises voice information representative of a first voice of the unauthenticated user that was captured by the microphone, wherein the analyzing comprises analyzing the voice information and stored voice information representative of a second voice of the verified user, and wherein the method further comprises:
based on the first result, determining, by the system, whether the voice information satisfies the defined match criteria with respect to the stored voice information,
wherein the determining of whether to authenticate comprises:
determining whether to authenticate the unauthenticated user as being the verified user or the unauthenticated device as being the verified device based on the second result and based on a third result of the determining of whether the voice information satisfies the defined match criteria with respect to the stored voice information.

21. The method of claim 18, further comprising:
in response to determining, based on the result, that the audio-related authentication information satisfies defined match criteria with respect to the stored audio-related authentication information, determining, by the system, that at least one of the unauthenticated user is authenticated as being the verified user or the unauthenticated device is authenticated as being the verified device; or
in response to determining, based on the result, that the audio-related authentication information does not satisfy the defined match criteria with respect to the stored audio-related authentication information, determining, by the system, that at least one of the unauthenticated user is not authenticated as being the verified user or the unauthenticated device is not authenticated as being the verified device.

22. The method of claim 18, wherein the unauthenticated device is or comprises at least one of an earbud or earphone device, an electronic headset device, an electronic eyeglasses device, or an augmented reality-virtual reality headset device that comprises at least two of a microphone, a sound sensor, or a sound speaker.
